(19) United States
(12) Patent Application Publication
(10) Pub. No.: US 2014/0122129 A1
(43) Pub. Date: May 1, 2014

(54) System and Method for Automated Patient History Intake

(71) Applicants: Blake J. LESSELROTH, Portland, OR (US); Robert S. FELDER, Portland, OR (US); Shawn M. ADAMS, Portland, OR (US); Phillip D. CAUTHERS, Happy Valley, OR (US); Gordon J. WONG, Portland, OR (US)

(72) Inventors: Blake J. LESSELROTH, Portland, OR (US); Robert S. FELDER, Portland, OR (US); Shawn M. ADAMS, Portland, OR (US); Phillip D. CAUTHERS, Happy Valley, OR (US); Gordon J. WONG, Portland, OR (US)

(73) Assignee: Dept. of Veterans Affairs, Baltimore, MD (US)

(21) Appl. No.: 14/147,191

(22) Filed: Jan. 3, 2014

Related U.S. Application Data
(63) Continuation of application No. 12/926,692, filed on Dec. 3, 2010.
(60) Provisional application No. 61/266,963, filed on Dec. 4, 2009.

(51) Int. Cl. G06F 19/00

(52) U.S. Cl. CPC G06F 19/322
USPC 705/3

(57) ABSTRACT

A system of automated patient history intake including a retrieval system for retrieving pharmaceutical information specific to a patient, a display system for displaying the pharmaceutical information, and a reconciliation system for reconciling the pharmaceutical information using visual data. A system for automated patient check-in including a retrieval system for retrieving pharmaceutical information specific to a patient, a display system for displaying the pharmaceutical information, and a reconciliation system for reconciling the pharmaceutical information using visual data.

### CROSS-REFERENCE TO RELATED APPLICATION

This application claims the benefit of U.S. Provisional Patent Application No. 61/266,963 filed Dec. 4, 2009, hereby incorporated by reference in its entirety.

### BACKGROUND OF INVENTION

a. Field of Invention

This invention relates to systems and methods for facilitating patient intake, and more particularly, to a system and method for automated patient history intake by supporting, for example, medication reconciliation, clinic check-in, demographic and insurance data verification, and allergy review in, for example, an ambulatory care setting.

b. Background Art

Handoffs in patient care (e.g. admissions, discharges, shift sign-outs, etc.) are high-risk settings where medical prescribing errors can occur. The inherent risk is likely due to discontinuity in care, fragmentation of health systems, and gaps in patient information. Although studies suggest that prescribing errors account for the largest portion of preventable adverse drug events, processes directed at reconciling medication lists can reduce discrepancies by up to 75% and prescribing errors by an estimated 80%. It is for this reason that multiple safety advocacy groups including the VA National Center for Patient Safety have called for initiatives to improve medication reconciliation (MR).

Medication reconciliation is the process of comparing the list of medications that a patient is taking with the list that the organization has on file. A complete reconciliation event also requires the point-of-service provider to update or amend any additions, changes, or corrections identified or generated during that encounter and furnishing a corrected list to the patient. A medication may include any prescription medication, herbal or nutritional supplement, over-the-counter agent, vaccine, or product designated by the Food and Drug Administration (FDA) as a drug.

The Joint Commission (formerly known as the Joint Commission for Accreditation of Healthcare Organizations) introduced medication reconciliation as a National Patient Safety Goal in 2005 with an expectation towards systematic implementation at all healthcare organizations by 2006. Since then, most healthcare institutions have struggled to meet both compliance standards and clinical intent. One reason for this difficulty is that the most effective and sustainable operational strategies remain uncertain. Furthermore, most published reconciliation efforts have been aimed at inpatient encounters where the healthcare organization ostensibly has greater control over the identification and distribution of medications. Ambulatory settings represent a separate set of challenges, and primary care delivers longitudinal, coordinated, and comprehensive care. As a result, it is a complicated care setting that can overwhelm the resources and cognitive workload of a primary care clinician. Additionally, although patients are the end-users of medications, they are often ill-equipped to correctly identify medications by name alone. Hence, collection of an accurate medication history can overextend existent clinic resources. Thus, the inventors herein have realized that it is incumbent upon healthcare organizations to devise better ways to accurately and reliably gather medication histories.

### BRIEF SUMMARY OF THE INVENTION

The Automated Patient History intake Device (hereinafter APHID system or method) includes a software and hardware technology application that allows patients to complete a variety of self-service activities. The APHID system permits patients to check in for ambulatory care appointments and verify health record data before meeting with their clinician. Locally written software run on networked computer workstations (e.g. patient kiosks) allows patients to confirm their contact and billing information, medical history, allergy list, and current medication list. New medical information furnished by the patient can be retrieved from a secure printer or viewed by a clinician using a Computerized Patient Record System (CPRS). In an exemplary embodiment, administrative data is securely routed to business departments using a Veterans Health Information System and Technology Architecture (VistA) email exchange server. It should be noted that any use or reference to a “Veterans” or “Portland” hospital throughout this description is for exemplary purposes only for implementation of the APHID system at a Veterans or Portland hospital, and should not be used to limit the scope of the invention. Thus the APHID system may be readily implemented at a general hospital, ambulatory care setting or another such facility.

The APHID system and method of the invention generally includes a kiosk-based patient portal that uses multimedia to gather an accurate medication history. The kiosk technology enables patients to review the name and picture of each medication recorded in CPRS. The kiosk-based self-service model also offers pre-registration and check-in capabilities to reduce administrative overhead and streamline clinical throughput. The APHID system and method is modular and scalable, thus enabling integration into a variety of ambulatory and quasi-ambulatory care settings. The APHID system and method also provides an extensible platform to support future functional components.

An objective of the APHID system is to enable patients to automatically check-in for their clinic appointment and verify selected health information prior to entering the clinic exam room. The APHID system improves the accuracy and completeness of a medication history by assembling an aggregate list of patients' medications and encouraging the patient to report any variation in adherence. Updated clinical information can then be printed or retrieved using Patient Data Objects (PDO) within the CPRS Text Integrated Utility (TIU) package. Administrative updates may be automatically sent to designated mail-groups owned by business entities to increase organizational efficiency. The kiosk-based self-service model is designed to reduce administrative overhead and cost by relieving the burden placed on clerical and mid-level clinical personnel to complete time-intensive check-in functions.

The APHID patient-interface software provides a streamlined set of web-based controls and dialog boxes to collect information from the patient. The APHID software can work with or without touch-screen capable displays and also accepts mouse or keystroke input. Furthermore, the medication review module, described in detail below, uses text and digital image prompts to gather a medication history from the patient.

With regard to identity authentication, patient privacy, and data confidentiality, patients access the APHID software and confirm their identity by swiping their PATIENT Identification Card (PIC) and completing several challenge questions. The software will only collect health information if the patient has an appointment that day. The APHID system is implemented using a client-server architecture, and the software executable is located on a server behind a hospital's firewall. The kiosk/clients are networked on a secure virtual local area network. Hence, attempts to compromise a single terminal would have a negligible impact on the APHID system and the healthcare system intranet. Finally, information furnished by the patient is stored within the VistA database, thus avoiding the inevitable challenges associated with managing and securing separate databases.

The APHID system is designed to reduce administrative overhead by assuming responsibility for many time-intensive functions otherwise delegated to administrative support, customer service representatives, and ancillary medical staff. For example, a single office clerk can proctor 3-5 APHID kiosk terminals simultaneously, reducing the total cycle-time for patient check-in and increasing overall clinic throughput. Similarly, the APHID history and reconciliation modules, described in detail below, help to collect a valid and complete medication compliance history prior to clinic intake. Similar tasks conducted by pharmacists and nurses can take an average of 15-20 minutes. Hence, the APHID check-in process can increase clinic throughput efficiency while simultaneously completing important business and safety compliance measures.

The APHID system optimizes FTE resources by parsing information into smaller subunits and triaging to the most appropriate business entity. For example, changes to the demographics can be securely emailed to enrollment representatives whereas insurance updates can be sent to the billing department. The APHID system also supports a variety of data output types for staff in order to optimize existent equipment and workflow. Providers and clinic staff can retrieve information using one of two optional printouts or by importing a formatted data object in the note charting section of the Computerized Patient Record System (CPRS). Again, the goal of electronic data capture is to close information gaps and better synchronize patient, provider, and information.

Research in electronic health records and clinical decision support systems has shown that providers are more likely to review and act on clinical information when interposed into pre-existent workflow processes and integrated into, for example, legacy health information systems. Pursuant to this goal, all clinical information entered at the kiosk can be retrieved by the medical staff using a class I CPRS notes package (text integrated utility/TIU). It should be noted that a class I CPRS notes package is specific to a Veterans Affairs facility. Thus as evident to those skilled in the art, a more generalized patient record system package may be used to retrieve clinical information in a hospital environment. When a note is generated, the information can be automatically embedded in the chart using specially designed patient data objects, which retrieve and display information in a concise and organized format. This approach capitalizes upon existent charting shortcuts and can be implemented without additional training. Furthermore, by using this strategy, no pre-existent clinical information is overwritten, and instead it remains the responsibility of the clinician to review the information and make changes to the medications or allergies.

The APHID software executable interfaces with the legacy VistA system, storing all patient information in specially written APHID files, and may be interfaced with other hospital systems. Retrieving and storing all information in VistA obviates the need to develop, manage, and protect separate patient data repositories. Information gathered from the patient does not overwrite national data and does not automatically update fields in the medical record. Instead, it is the responsibility of the medical staff to review information using one of several CPRS interface devices and affect final changes in the health record. The patient-entered information can be used by employees to maintain accurate contact and health insurance information, update the allergy profile, gather a past medical history, and identify changes in the patient's medication profile.

The APHID technology uses a client-server network architecture implemented over a facility's local area network. The APHID executable software can run on a local organization server, and patients using client kiosks access the software. The kiosk firmware may take a variety of forms including thin-clients, personal computer workstations, or freestanding kiosk cabinets.

A server hosting the APHID executable does not run the executable with each patient encounter. Rather, the server is a virtual warehouse that client workstations reference for the executable, the configuration file, and the medication image database. Each time a terminal session is initiated, the executable is launched from the server and run on the terminal device. The benefits of this structure include storing database login credentials on a physically secure server while optimizing speed and performance at the terminal level.

All networked devices associated with the APHID system are connected on a closed VLAN. The server and the terminals are assigned static IP addresses. The system administrator or the facility system manager can create and apply access control lists (ACLs) to all of the facility and CBOC switches to regulate network communications within the APHID VLAN. Devices on the VLAN may only communicate with each other and VistA nodes.

The APHID executable is hosted on a facility server. The server is located inside the closed VLAN and assigned a static IP address. Network traffic within and across the VLAN is managed using ACLs. This configuration affords the greatest amount of system security. It should be readily understood that instead of a VLAN, a standing network or toolbar version may be used.

A standard user profile is loaded onto each client's operating system registry, which automatically launches a Delphi executable during the boot process. This configuration prevents unauthorized user access to any other applications, network locations, or operating system parameters. All users, except a system administrator, will only see the APHID interface whenever the client appliance is powered up. The generic user profile has a generic account and local credentials to access to the APHID workgroup. The APHID program does not require domain access to retrieve health information from the VistA exchange server. Instead, broker calls made by the client executable interact with the exchange server via a dedicated port equipped with ACLs.

Several potential hardware setups can be applied to create an end-terminal patient kiosk. For example, a facility can use thin-client hardware or the facility can use common PC hardware configured to limit end-user activities. Other enterprises may choose to run software on industrial-grade kiosk devices or consumer off-the-shelf kiosks similar to those used in commercial retail and banking.

For thin-client hardware, each flash drive processor (“thin-client”) is deployed with an operating system and VISN thin-client image. The image is modified so that only the executable shortcut is accessible. A write filter configures the power-save option to prevent the workstation from hibernating and to prevent unauthorized use of the software.

Attributes unique to the thin client hardware include a flash memory drive, stripped version of the Windows XP-Embedded operating system, a lower cost, and a smaller physical footprint. The thin client automatically logs into a user desktop, and the desktop configuration is limited to pre-specified user options consistent with facility policies. The device is not registered on the network domain. A write filter (i.e. software preventing local configuration modification) is applied to prevent changes and to limit unauthorized data storage. Furthermore, workstation maintenance is streamlined when runtime errors are encountered, and the last known functioning configuration is immediately accessible following system reboot.

For the APHID system, information displayed to the patient by a graphical user interface (GUI) is retrieved from production VistA files using MUMPS remote procedure calls. In order to protect data integrity and validity, patient input does not go directly into national VistA files. Data is stored in a local VistA file to be reviewed by an authorized hospital employee before it can be transcribed to a national file. No data is cached by the application located on the client. Data stored in the local file can be routed to a variety of output devices. Demographic and insurance information is automatically sent to the enrollment and billing offices respectively through use of the VistA Mailman software inside the firewall. Patient histories can be automatically sent to network printers or retrieved within CPRS using patient data objects. All data exchange pathways are part of the APHID program code and data transmission cannot be rerouted by clinic employees or patients.

The APHID GUI is written in Object Pascal (Borland Delphi). The executable is housed on a network server and accessed remotely. The device accepts direct patient data input either via card reader, a touchscreen monitor, or by keyboard/mouse entry. As discussed in detail herein, the interface allows patients to check-in for scheduled appointments, verify and update demographic and billing information, and verify and update medical information. The executable has limited functionality and will not allow the user access to any other VistA features, software applications, or operating system parameters.

The APHID Set-up program is a separate GUI standalone written in Object Pascal (Borland Delphi). The set-up program, in addition to establishing basic parameters, determines how the APHID kiosk program will handle many situations. It is designed to allow a site to either enter some basic local parameters, or to customize the product to a predetermined level of precision.

The APHID system application is placed on a remote server and accessed by the client. A standard user profile (machine account) is loaded onto the operating system registry which automatically launches the Delphi executable during the boot process, thus preventing unauthorized access to any other applications, network locations, or operating system parameters. Any user without technical knowledge and requisite administrator credentials will only be able to see the APHID executable whenever the client appliance is powered up. The generic user profile is furnished with a generic local account (not to be confused with a generic VistA service account) and local credentials to allow access to the APHID workgroup where the executable and JPEG medication files are stored. However, the APHID program does not require domain access to retrieve health information from the VistA exchange server. Instead, broker calls made by the client executable interact with the exchange server via a dedicated port equipped with access control lists.

The check-in module tracks appointment times and includes guardrails to prevent the patient from using the history-entry module if there is insufficient time available. The purpose of this function is to limit potential disruptions to clinical workflow or bottlenecking of patient throughput. The guardrails can be removed at the discretion of the program administrator. Check in can be further refined, if needed, to limit check-ins, for example, by location so that in a specific clinic area, you can only check into clinics situated there. Thus the decision logic may enable selection by partial clinic name, exact clinic name, stop code or physical location.

APHID accesses the patient's medication profile using predetermined files and RDI (remote data interoperability) calls to assemble a medication list and present the patient with the name, SIG, and picture for each medication dispensed that is known to the hospital system (includes remote and non-hospital-specific medications as well as recently expired or discontinued medications). Prior medical history is stored for future use and auto-populates previously indicated diagnoses.

All information verified or changed by the patient is stored in a VistA file until overwritten by the patient's next use of the system (only the most current information is stored). The data will only be entered into the medical record if and when it is reviewed by the provider in a progress note. The APHID information is accessed for the notes via Patient Data Objects (PDO). These objects may be built into note templates, as well as being available to all clinic staff through CPRS shared templates. After a predetermined time period (e.g. 3 days), the PDO will no longer access the data (though it remains in the file) due to concern that it may no longer be accurate. PDOs include the information the patient entered, as well as any changes to the medications since APHID was completed (new orders at the last visit, medications discontinued, etc.).

RDI is used via standard RDI calls after first checking the cache for recent data. If RDI is unavailable, that information is filed and returned both to the patient and to the provider in the PDO (that remote medications were not able to be evaluated). If the data is available, it is also stored in a temp file to ensure that it is accessible for after-visit summary in case the RDI is down at the time the data is needed.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and, together with the detailed description, serve to explain the principles of the invention. In the drawings:

FIG. 1 is a diagram illustrating the logic architecture of the APHID system according to the invention;

FIG. 2 is a diagram illustrating a distributed workflow model for kiosk deployment;

FIG. 3 is a diagram illustrating a centralized workflow model for kiosk deployment;

FIG. 4 is an exemplary APHID screen-shot illustrating patient initiation of an APHID session and check-in for their appointments by swiping a Patient Identification Card through a magnetic-card swipe reader connected to a client workstation;

FIG. 5 is an exemplary APHID screen-shot illustrating a patient's use of the demographic screen to review, verify, update, or correct demographic information;

FIG. 6 is an exemplary APHID screen-shot illustrating a free text box requiring a patient to enter their chief complaint for the visit, and other medical information;

FIG. 7 is an exemplary APHID screen-shot illustrating an allergy review module showing all allergies within the CPRS Allergy/Adverse Reactions package;

FIG. 8 is an exemplary APHID screen-shot illustrating a medication compliance survey administered to a patient;

FIG. 9 is a diagram illustrating a layered model of APHID implementation;

FIG. 10 is a diagram illustrating a facility local area network configuration;

FIG. 11 is an exemplary APHID screen-shot illustrating a CPRS Patient Data Object (PDO) shown as a part of a Primary Care intake note;

FIG. 12 is a diagram illustrating an APHID network including a closed VLAN created by applying port ACLs to the facility switch;

FIG. 13 is a flowchart of appointment check-in program logic;

FIG. 14 is a diagram illustrating clinic criteria combined using Boolean operators to create sets of kiosks or clinics;

FIG. 15 is a flowchart of functional module restriction logic;

FIG. 16 is a flowchart of workflow and functional logic for allergy review;

FIG. 17 is a flowchart of APHID executable logic matching pharmaceutical images with prescriptions;

FIG. 18 is a graph illustrating proportion of scheduled primary care appointments (e.g. Portland primary care and community basic outpatient clinics) checked-in using APHID software (N>80,000);

FIG. 19 is a graph illustrating proportion of scheduled specialty care appointments (Complex Diagnostic Unit and Short Stay Care) checked-in using APHID;

FIG. 20 includes graphs illustrating usability scores from a survey instrument distributed to patients;

FIG. 21 is a diagram illustrating privacy and security measures implemented throughout the architecture;

FIG. 22 is a diagram illustrating three domains of a healthcare kiosk activity system;

FIG. 23 is a flowchart of suggested workflow for an ambulatory clinic;

FIG. 24 is a flowchart of a proposed decision heuristic to manage medication discrepancies identified at the point-of-service;

FIG. 25 is an exemplary APHID screen-shot illustrating patient data objects located in the templates tray;

FIG. 26 is an exemplary APHID screen-shot illustrating a CPRS toolbar and reconciliation link;

FIG. 27 is an exemplary APHID screen-shot illustrating a patient handout form;

FIG. 28 is a workflow diagram providing an exemplary workflow strategy using the APHID system of the invention; and

FIG. 29 is a flowchart of an exemplary chemotherapy clinic work-flow model.

### DETAILED DESCRIPTION OF EMBODIMENTS OF THE INVENTION

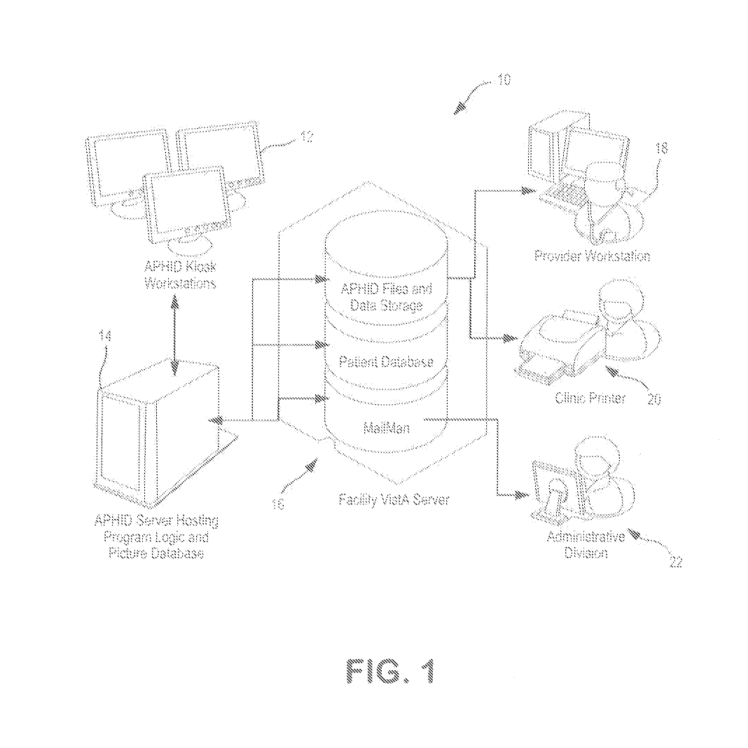

Referring now to the drawings wherein like reference numerals are used to identify identical components and steps in the various views, the Automated Patient History Intake Device (“APHID” system and method 10) will be described in detail with reference to FIGS. 1-29.

As shown in FIG. 1, APHID system and method 10 may generally include kiosk technology including patient-facing client workstations 12 (e.g. APHID kiosks) connected to a server 14 running consumer-directed software. As listed in Table I, the technology may include an APHID executable, a setup executable, a medication image file database, new VistA database files, CPRS patient data objects, and a client-server network.

TABLE I
Components of the APHID system and method

| Component | Description | Reference |
|---|---|---|
| APHID | Provides patient facing GUI for | Business and User |
| executable | data review | Manual |
| Setup | Provides GUI for kiosk and busi- | Technical Manual |
| executable | ness rule configuration | |
| Configura- | Provides the access credentials | Patch Documentation |
| tion file | for VistA | and Technical |
| | | Manual |
| Picture | Provides JPEG medication images | Technical Manual |
| database | for the APHID med recon module | |
| VistA | Special VistA files that store | Patch Documentation |
| APHID | data captured using APHID exe- | and Technical |
| database | cutable | Manual |
| Patient data | CPRS TIU objects that call | Patch Documentation |
| objects | information stored in APHID | and Technical |
| | VistA files | Manual |
| Network | Client-server model with cus- | Business and User |
| architecture | tomer kiosk end terminals | Manual |

The APHID executable is primarily a graphical user interface that allows a patient to securely view selected information, interact with VistA packages, and signal changes in their history. The setup executable allows an administrator to install and configure the APHID system and local business rules. The setup executable also provides a graphical user interface to enable the system administrator to adjust configurations, add local business rules, add workstations, and retrieve setting information. The medication image database is a collection of digital medication photographs compressed using the JPEG format and stored on a server, and images are indexed and can be matched with medication information retrieved from VistA. The APHID architecture uses VistA to store new clinical and administrative data, and class II APHID files are implemented to hold information collected at the workstation. As discussed above, it should be noted that the terms class I, II etc., are specific to a Veterans Affairs facility, and are provided for exemplary purposes only. Thus as evident to those skilled in the art, a more generalized file system may be implemented for holding information in a hospital environment. New patient data objects (PDO) provide a means to retrieve and display information using the CPRS text integrated utility package (TIU). The network may include client workstations connected on a secure subnet to a central server running the APHID executable, and each workstation may use a kiosk configuration to limit user activity and ensure network security. Other components of the APHID system may include a facility VistA server 16, a provider workstation 18, a clinic printer 20 and an administrative division 22, the functions of which will be discussed herein.

The following description provides an overview of the APHID system and method used in a clinical scenario and two high-level deployment models. The archetypal setting for the APHID system is a primary care clinic offering a single encounter type (e.g. a primary care appointment). Nonetheless, APHID configuration settings enable a high level of customization, and permit facilities to use the product in, for example, urgent care clinics, specialty clinics, multi-use and procedural areas, and centralized check-in centers.

Distributed Check-in Model

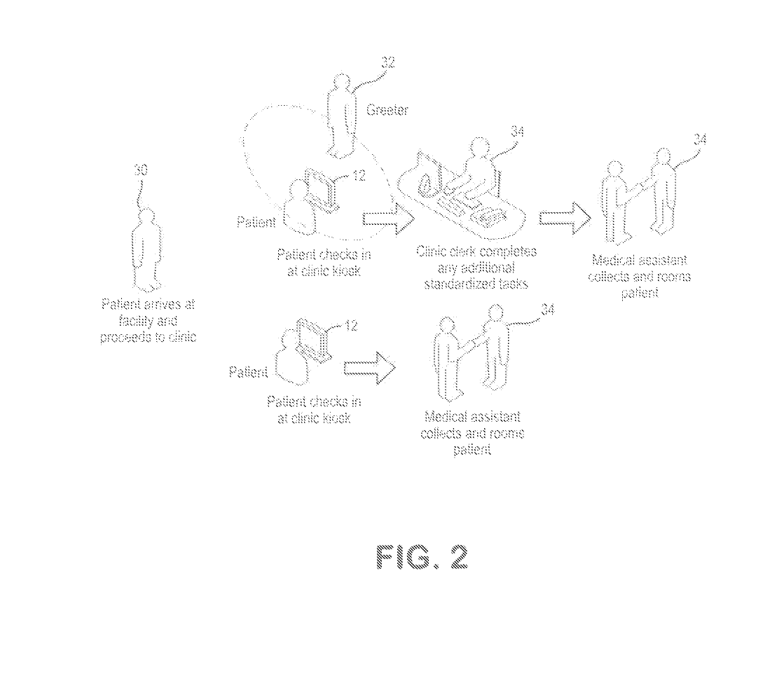

Referring to FIG. 2, a distributed check-in model is shown in which APHID kiosks 12 are located proximally to clinics (e.g. the clinic waiting room or reception area). Patients 30 may only check-in for clinics offered at a particular kiosk location. The distributed check-in model ensures that the patient is present in the clinic waiting area and able to participate in any structured intake process immediately after using the kiosk. This model would be beneficial for clinics that require the patient to complete any additional documentation materials, participate in a standard intake process, or furnish diagnostic materials such as blood specimens. Benefits of the model include, for example, less problems associated with way-finding, immediate availability of clinic personnel, and the ability to link check-in with other clinic-based processes.

In an exemplary scenario, a patient typically presents to the clinic waiting area and is directed to an open terminal by a greeter 32 or circulating staff member. The patient checks in for the appointment and completes all available functional software modules, and then sits in the waiting area until called by a staff member 34, or until after an intermediate staff member 36 completes any additional standardized tasks. The clinic support staff recognizes a patient has checked-in by using the VistA appointment manager or by receiving a printout. The patient is roomed and during the intake process, a CPRS note is generated. The note title is associated with boilerplated text that may include the APHID data objects. The staff member reviews the data with the patient and corrects or addends any incorrect or incomplete responses. The clinic provider is then notified that the patient is ready to be seen and the clinic provider reviews the intake note either immediately before or during the encounter. The provider has an opportunity to act upon any clinical information detailed in the note (e.g. resolve medication discrepancies highlighted in the data object). Administrative data may be automatically forwarded via VistA MailMan to facility business departments.

The distributed check-in model requires the clerk, medical assistant, and clinician to be familiar with the APHID system and the output, and for each business department to check new email alerts and to have a policy in place for managing new data streams.

Centralized Check-in Model

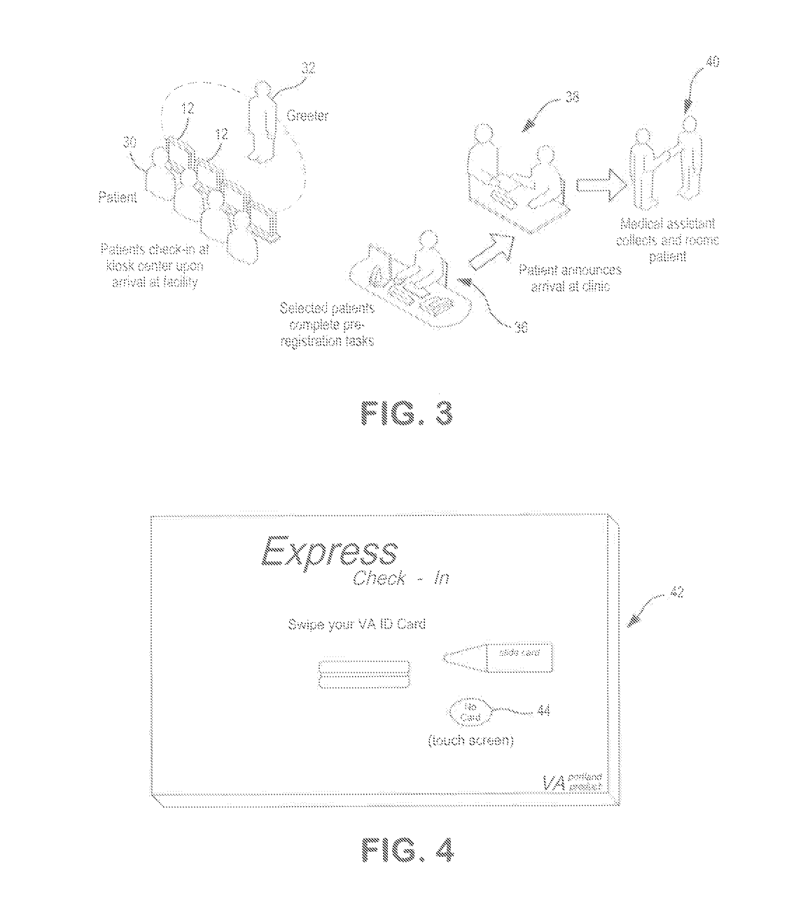

Referring to FIG. 3, in the centralized check-in model, multiple kiosks 12 are grouped together in a centrally located area within the facility. Patients 30 are encouraged to check-in for all appointments from a single location before dispersing to the respective clinical locations for eventual clinic intake. The centralized check-in model ensures that all patients are exposed to a single check-in procedure or chain of intake steps (e.g. pre-registration) prior to being seen in clinic. Benefits of this model include, for example, a high level of process standardization to address any mission critical goals such as vesting or insurance review, simplified configuration logic, consolidation of resources such as personnel, a greater opportunity to take advantage of branding, and a more consistent kiosk experience.

In an exemplary scenario, a patient 30 enters a facility and immediately proceeds to a check-in kiosk located in the facility lobby or reception atrium. A greeter or circulator 32 directs the patient to an available terminal 12, at which the patient completes the check-in module and any other software modules deployed at the terminal. The patient can collect a printout that may include clinic names and locations, and thereafter, the patient may be directed to an administrative clerk to complete any pre-registration tasks at location 36 such as furnishing a copy of a third-party insurance card. The patient then proceeds to the first clinic area for intake, where the patient may be asked to announce his/her arrival to clerical staff at location 38, and is then roomed and processed at location 40 similarly to the scenario outlined in the distributed check-in model.

The centralized check-in model requires the medical assistant and clinician to be familiar with the software output modalities, and requires each business department to check new email alerts and to have a policy in place for managing new data streams. Finally, the centralized check-in model requires a dedicated set of personnel to be familiar with the patient-facing software and any associated business processes linked to pre-registration.

The APHID system software will now be described in detail.

Graphic User Interface (GUI) Software overview (APHID Executable)

The GUI front-end may be written in Delphi (Object Pascal) and provides a portal for patients to view selected health record data, signal arrival in clinic, or update their personal information. It interfaces directly with a facility's VistA database using MUMPS RPCs (Remote Procedural Call), which is the APHID systemming method used by the MUMPS language to implement a function or exchange data. This interface allows for seamless data exchange with a facility's legacy record. Information displayed to the patient is retrieved from class I VistA patient files, and any new information furnished by a patient at a terminal kiosk is stored in a local APHID VistA file. Information stored in the local file can be repackaged as a print out, email, or CPRS patient data object depending upon the clinical need, and bidirectional data exchange between the executable and the database is managed using class III remote procedure calls (RPCs). Again as discussed above, it should be noted that the terms class I, II, III etc., are specific to a Veterans Affairs facility, and are provided for exemplary purposes only. Thus as evident to those skilled in the art, a more generalized set of remote procedure calls may be used for a hospital environment.

The clinic check-in, demographic and administrative data review, clinical history surveys, allergy review and updates, and medication reconciliation functions of the APHID system software will now be described.

Check-in Module

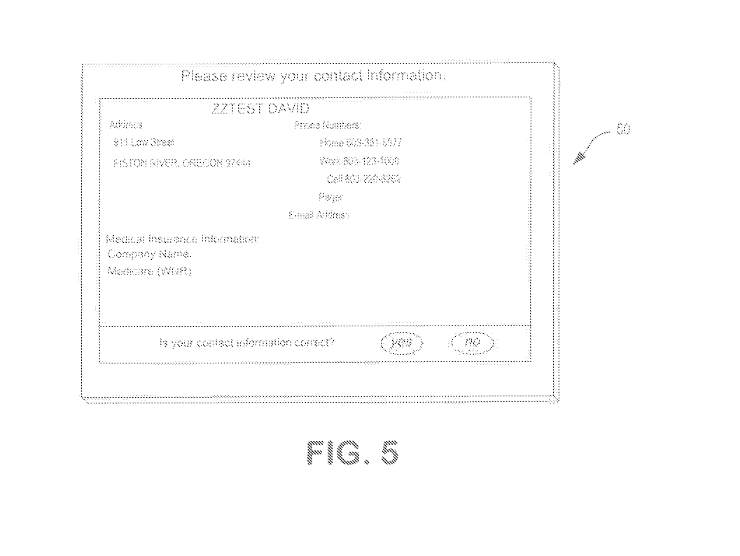

Referring to FIG. 4, a check-in module may use a generic VistA account enabled with an appointment check-in menu option. The check-in module may be configured to recognize data entry from a card-swipe input so that a patient can begin a session using a Patients Identification Card (PIC). Patient identification data is extracted from the ID card and passed to the appointment manager program, triggering automated check-in.

Similarly, the APHID executable uses a dedicated VistA account to broker data exchange between each client and the VistA database. As shown in FIG. 4, patients initiate an APHID session and check-in for their appointments by swiping a PIC through a magnetic-card swipe reader connected to the client workstation, as exemplified by the check-in screen 42. If the patient does have a magnetic card, the patient may check-in by touching screen 42 at location 44 and proceeding. The APHID executable uses the patient's information to retrieve the correct patient record and uses hidden access credentials to fetch and display patient data.

Administrative Module

Referring to FIG. 5, an administrative module may include a set of simple questionnaires to verify and update the patient's demographic and billing information.

Demographics

As shown in FIG. 5, the patient can use a demographic screen 50 to review, verify, update, or correct demographic information during the clinic encounter. The APHID system retrieves information stored in VistA and presents the data to the patient on a single screen. The patient is given the opportunity to verify or make changes to the displayed data. Although the APHID system can collect and store patient data, if national VistA files are not automatically updated, staff members may vet all information submitted by patients.

Third Party Billing Capture

The billing capture module allows a patient to verify and update third party insurance data at each encounter. Although the APHID system can collect and store patient data, it does not automatically update national VistA files. Further, it is often necessary to store an image of the patient's insurance card. For this reason, data may be forwarded automatically to billing department representatives using VistA MailMan. Hence, it is necessary to establish a standard process with the billing office to address new information notifications and data capture.

Medical History Module

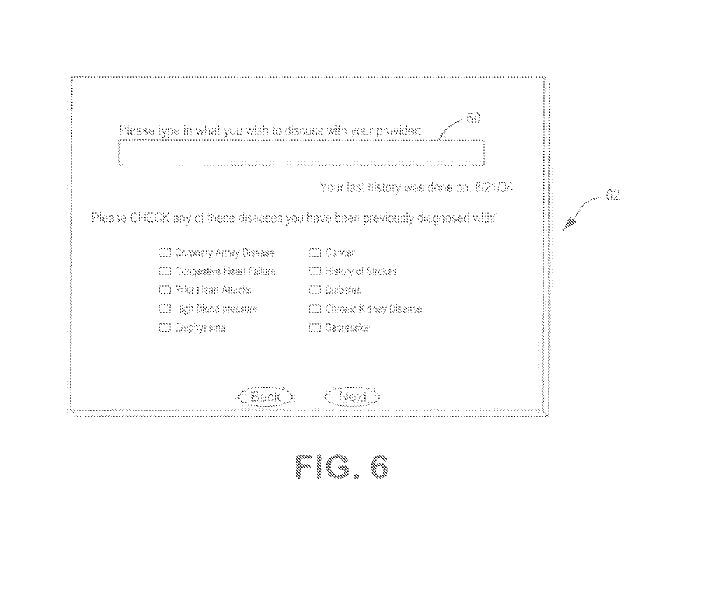

Referring to FIG. 6, the medical history module collects an abbreviated list of past medical illnesses. A free text box 60 shown on the medical history screen 62 allows the patient to enter their chief complaint for the visit. In an embodiment, ten diagnoses that could alter the course of the visit (cancer, heart disease, high blood pressure, etc. . . . ) are displayed along with interactive checkboxes. The patient uses the checkboxes to indicate any previously diagnosed diseases, and survey results are stored and displayed during subsequent kiosk sessions.

Allergy Module

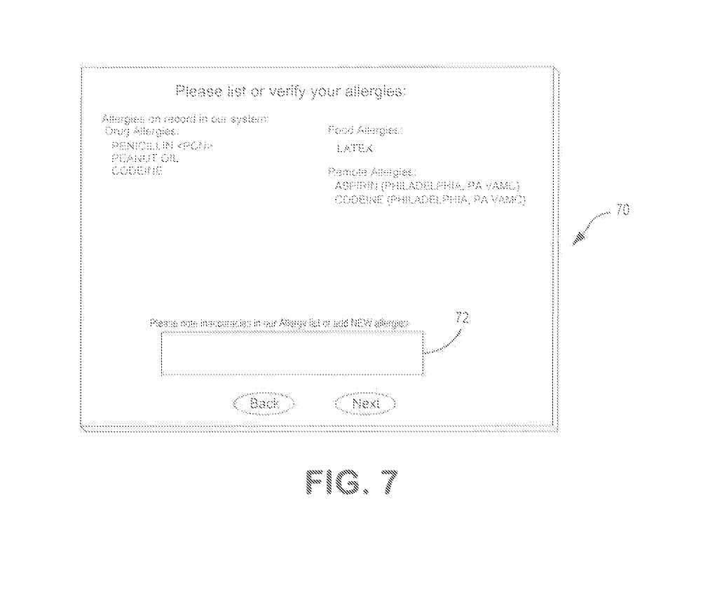

Referring to FIG. 7, the allergy review module shows all allergies within the CPRS Allergy/Adverse Reactions package. Allergies are displayed at screen 70 as a static list and cannot be updated, and a patient may indicate corrections or additions to the allergy list using a free text input box at location 72.

Reconciliation Module

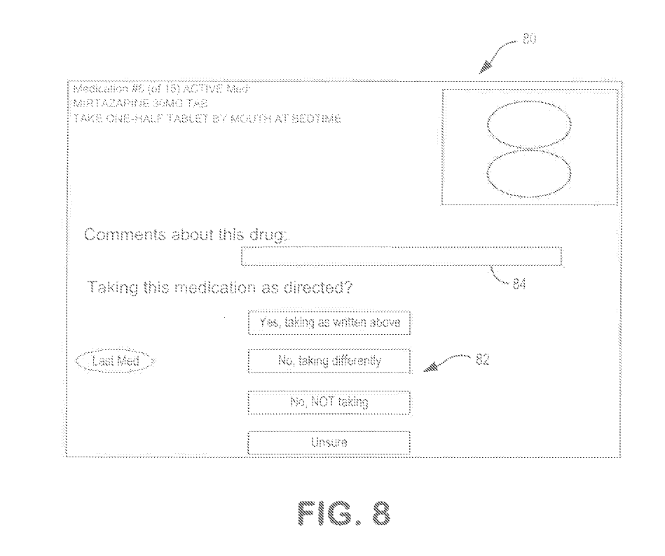

One primary function of the APHID system and method is to capture an accurate list of a patient's current medications and adherence patterns. Referring to FIG. 8, the APHID system administers a medication compliance survey 80 to the patient. The survey includes a composite medication list and a set of response buttons. The composite medication list may include local and remote active medications, local and remote medications that have expired within, for example, the last 6 months, and local non-hospital meds. Each medication is displayed on-screen individually and the patient is required to indicate adherence using, for example, one of four touch-screen buttons at 82: Yes taking as written above, No, taking differently, No, not taking, or Unsure. Patient cannot advance to the next medication until current medication is addressed. A free text box at 84 is also available for patients to enter comments about each medication. After the medication list is reviewed, an additional screen requires the patient to record any new medications, over-the-counters (OTCs), or supplements procured outside the hospital. The medication name, dosage, and frequency are requested, but not mandatory.

Administrative Setup Program Overview (Setup Executable)

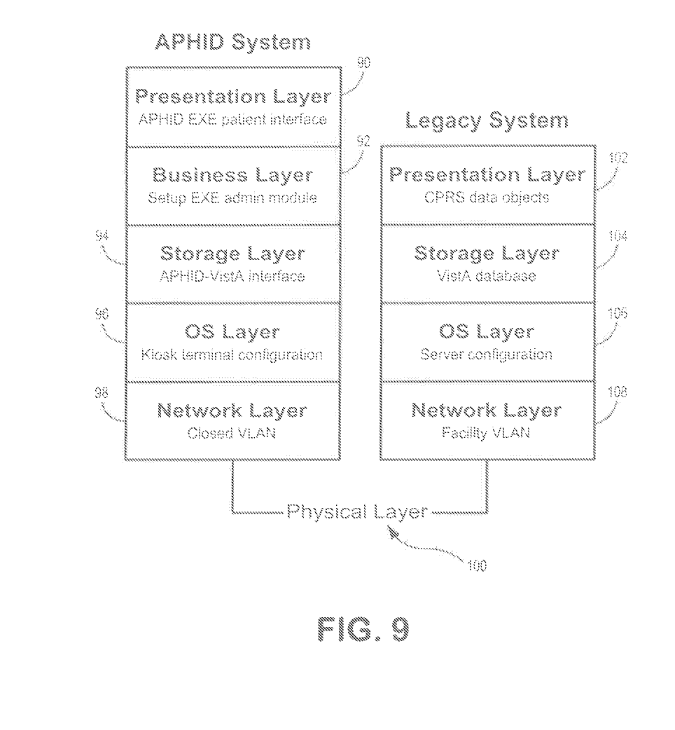

It is useful to discuss APHID using an implementation view or layered model of technology function. Referring to FIG. 9, a layered model permits a simplified discussion of the system and directs focus on the modular elements of that system. The APHID presentation layer at location 90 is where the actual patient portal software resides. As stated in the previous section, the APHID system provides a patient interface and a means for exchanging data with the VistA database. The business layer at location 92 provides the foundation for all program behavior, and it is at the business layer that the user configures the parameters of all APHID module function. A storage layer is provided at location 94. The operating system layer at location 96 provides the utility software platform to run all executable software and is the layer where user permissions and hardware configurations are set. The network layer at location 98 is responsible for moving information from one host to another. This layer implements the Internet protocol (IP) and provides the rules governing secure information exchange. It is at this layer that the system administrator invokes data control protocols to limit Internet traffic, isolate sections of the local area network, and ensure facility security. Finally, the physical layer at location 100 may include all the actual equipment that allows users to interact with the system, host programs, and exchange data between source and destination. The legacy system may likewise include a presentation layer at location 102, a storage layer at location 104, an operating system layer at location 106 and a network layer at location 108.

The administrator setup program (e.g. setup executable) is a complementary software application that enables the user to install the APHID executable, configure terminal workstations, and set parameters for program business rules. The setup executable may be a MUMPS application with a DELPHI GUI. The program allows for running of the APHID system and is installed before installation of the APHID executable. The APHID system provides an interface to set program business rules including check-in timer guardrails, clinic check-in permissions, and functional module selection. Each business rule dictates how the APHID system will behave in a given clinical scenario. Business rules can be applied at the facility, division, or clinic level depending upon local enterprise needs and workflow demands.

The user setup executable also permits an administrator to add and identify a terminal kiosk on the APHID system network. Each kiosk is assigned a static IP address and is given a set of parameters in order to function predictably based upon deployment location and enterprise needs. Each new kiosk added to the network can run a set of default parameters to expedite network upgrades, and an administrator can overwrite these defaults using the setup program.

MUMPS Software and Data Management Overview

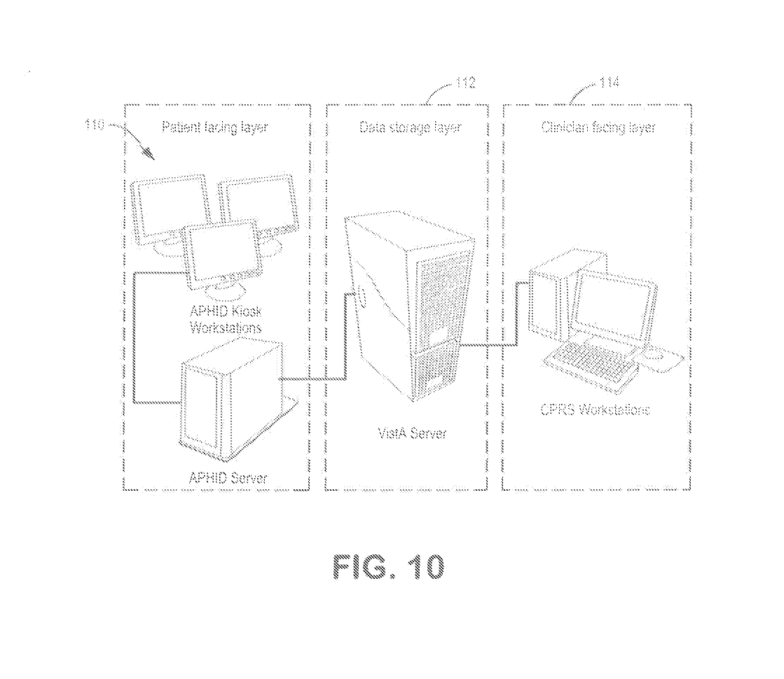

As shown in FIG. 10, the APHID system and method includes two components: the front-end GUI 110 and the back-end interface and data storage system 112. The clinician facing layer is provided at location 114. New MUMPS files installed in the facility's legacy VistA production environment store all information collected through the GUI. This architecture limits risk of data compromise by leveraging the security and certification accreditation applied to facility electronic health record storage.

The APHID-VistA Database

The APHID data repository is part of the production VistA database. A MUMPS interface manages data exchange with the APHID GUI Executable and the APHID Setup Executable. Information displayed by the GUI is retrieved from the production VistA files using MUMPS remote procedure calls. Data furnished by the patient is preferably not stored within the executable or national VistA files, and the executable does not overwrites the medical record. Instead, information collected at the GUI is stored in Class II VistA files. This information is then routed to appropriate staff that, in turn, can make updates using CPRS or VistA, which provides a beneficial data validation process. For this reason, data is routed to the correct department using a variety of output devices, and demographic and insurance information can be automatically sent via VistA email to for example, the enrollment office and billing office group email addresses. Patient histories can be automatically sent to network printers, embedded in CPRS note templates, or retrieved individually by using patient data objects. All data exchange pathways are part of the APHID system code. To prevent outdated information from being used, patient histories are viewable for a limited period, for example, 3 days.

The Picture Database and Picture Matching Function

The history program provides for a patient to review a list of their current and recently expired and discontinued medications and identify any discrepancies. The active medication list, non-hospital medication list, remote hospital medication list, and, for example, six months of expired/discontinued medications are retrieved from the patient record. Each prescription stored in the patient dispense file has a national drug code (NDC) number assigned by the Food and Drug Administration. That number is a unique index term and may be used to cross-reference with JPEG pictures stored on a local server. This logic allows the software to match the dispensed medication to the pharmaceutical picture with a high degree of accuracy.

Patient Data Objects

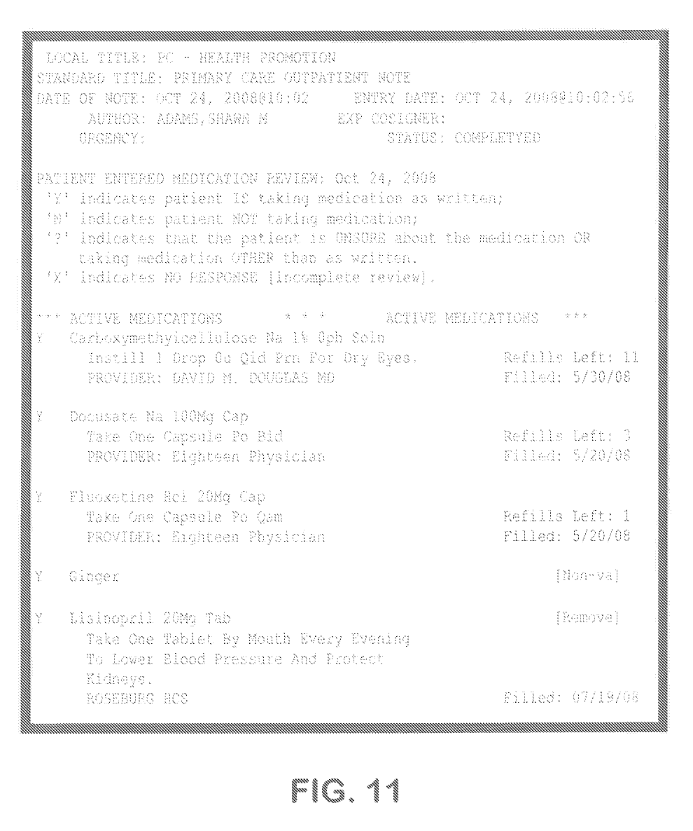

Referring to FIG. 11, providers can use CPRS to retrieve, view, and document information gathered at the kiosk. All patient furnished information stored in VistA can be viewed using Patient Data Objects (PDOs), which are small MUMPS routines that retrieve data entities within VistA and print them to chart notes in the Text Integrated Utility (TIU). When the provider is charting data in the CPRS notes tab, APHID PDOs can be inserted into the note. Alternatively, APHID PDOs can be added to boilerplates associated with existing note titles.

Network Overview and Deployment View

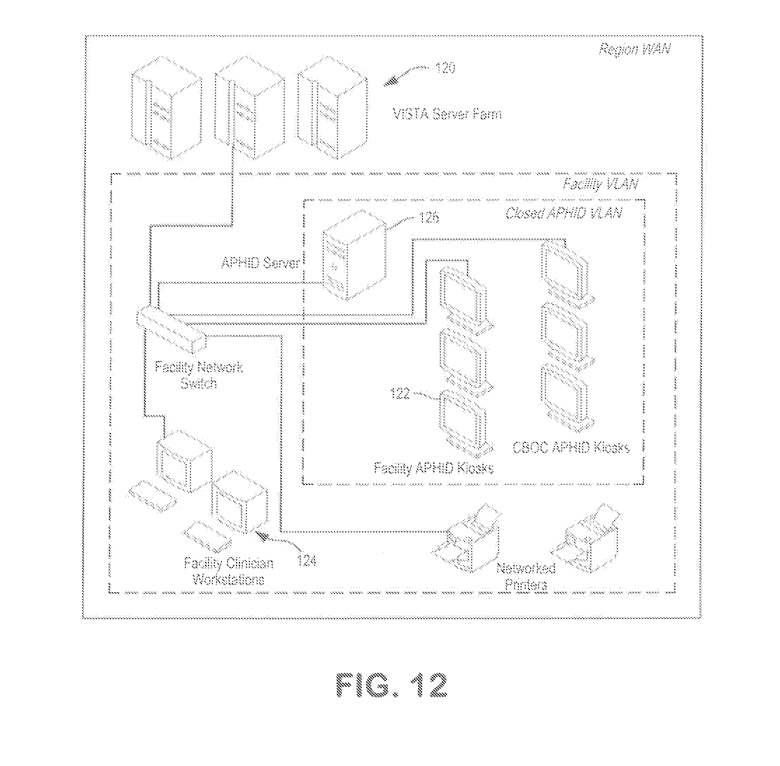

Referring to FIG. 12, the APHID self-service solution uses a client-server configuration implemented on the facility's local area network. The APHID executable software typically runs on a local organization server 120 such that patients using client kiosks 122 access the software. The kiosk firmware may take a variety of forms, such as computer workstations including a flash drive processor, touch-responsive monitor, keyboard, mouse, and magnetic stripe reader. Alternatively, personal computer workstations or dedicated devices 124 such as freestanding units or electronic notepads may be used. It should be noted that notepads require a secure wireless network isolated from the facility VLAN.

The client workstations connect to a local server 126 that hosts the APHID executable, and in turn, the server connects to the facility's VistA database. To ensure network security and integrity, the APHID server and workstations are configured on a closed virtual local area network (VLAN) and network traffic is managed using port access control lists (ACLs). This setup provides cost effectiveness, flexibility, a small physical footprint, and low maintenance needs. This network structure is scalable to meet a variety of facility sizes and deployment configurations, and furthermore, components can be easily modified to meet each facility's operating budget and existent resource allocation.

Business Logic Overview

The APHID system can be configured to support a diverse array of local workflow procedures and provincial enterprise practices. Although the APHID software can be installed using system defaults to streamline implementation for small facilities or facilities with limited IT resources, it is possible to adjust business logic to accommodate a variety of physical environments and clinic-specific workflow expectations. The following description provides an overview of the options available and the associated logic algorithms.

Program Timer Restrictions

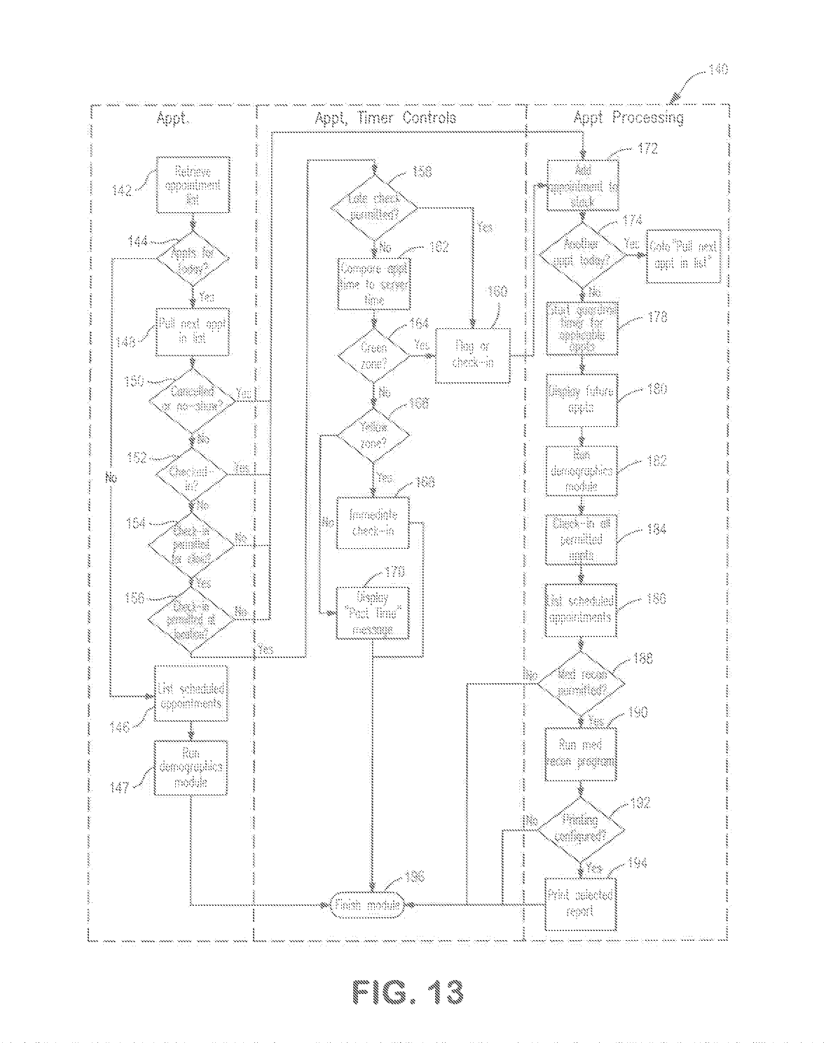

As shown in FIG. 13, check-in module 140 tracks appointment times and may include guardrails to limit clinic throughput delays when patients are behind schedule. The purpose of this function is to limit potential disruptions to clinical workflow or bottlenecking of patient traffic. For example, if the patient arrives with sufficient time to complete all software modules before the appointment, the APHID system will allow clinic check-in and run additional functional modules. However, if the patient appears at the terminal without sufficient time to complete program tasks, the APHID system will check the patient in and bypass selected functional modules (e.g. medication review). This feature limits disruption to clinics operating with tight appointment slots. If the patient attempts to check-in at the kiosk after the designated no-show cutoff time, the APHID system will not allow check-in and display screen messages redirecting the patient to a clerical assistant. It is also possible to block check-in for clinics needing a different check in system, or to only perform check in for clinics not needing the medical/medication review modules. These the guardrails can be removed at the discretion of the APHID system administrator.

In further detail, at initiation, the appointment list is retrieved at location 142. At location 144, the appointments for the day are verified, and if no appointments are scheduled, the APHID check-in module moves to location 146 for listing scheduled appointments, and thereafter, to location 147 to run demographics module. Alternatively, demographics and insurance may be run first, and thereafter, that day's or future appointments may be listed. If appointments are scheduled, the APHID check-in module pulls the next appointment at location 148, verifies cancellation/no-show at location 150, verifies check-in at location 152, verifies check-in permitted status for the clinic at location 154, and verifies check-in permitted status for the clinic location at location 156.

At location 158, the late check-in status is verified, and if late check-in is permitted, then the check-in is flagged at location 160. Alternatively, at location 162, the appointment time is compared to the server time, and the respective green and yellow zones are verified at locations 164, 166. At location 168, the patient is allowed immediate check-in, and at location 170, a “past time” message is displayed.

At location 172, the appointment is added to the stack upon a positive verification at location 156. At location 174, APHID check-in system 140 verifies the presence of another appointment for the day, and moves to “pull next appointment in list” at location 176 upon a positive verification. Upon a negative verification at location 174, system 140 starts guardrail timer for applicable appointments at location 178, displays future appointments at location 180, runs the demographic module at location 182, checks-in all permitted appointments at location 184, lists scheduled appointments at location 186, and verifies medication reconciliation at location 188. Upon a positive verification at location 188, system 140 runs the medication reconciliation program at location 190, verifies printing configuration at location 192, prints the selected report at location 194, and completes the check-in procedure at location 196.

Privacy and Abandonment Timers

Since it is important to restrict access to patient information and ensure patient privacy, each APHID functional module automatically closes and restarts after a preset duration of inactivity. These session timeouts reduce the probability of unauthorized access if the patient leaves the terminal before completing the APHID system. The APHID system flashes a warning message before closing, providing an opportunity for patients that require more time to continue the session. Also, several keyboard combinations can be used by staff personnel to immediately close the APHID system, with or without saving any data. Exemplary keyboard commands include:

F10→closes the APHID system immediately without saving material.

F4→restarts the APHID system and provides user with option to save data.

F2→shows the IP address for the kiosk and configuration settings.

F1→provides version and contact information.

Restrictions and Parameters

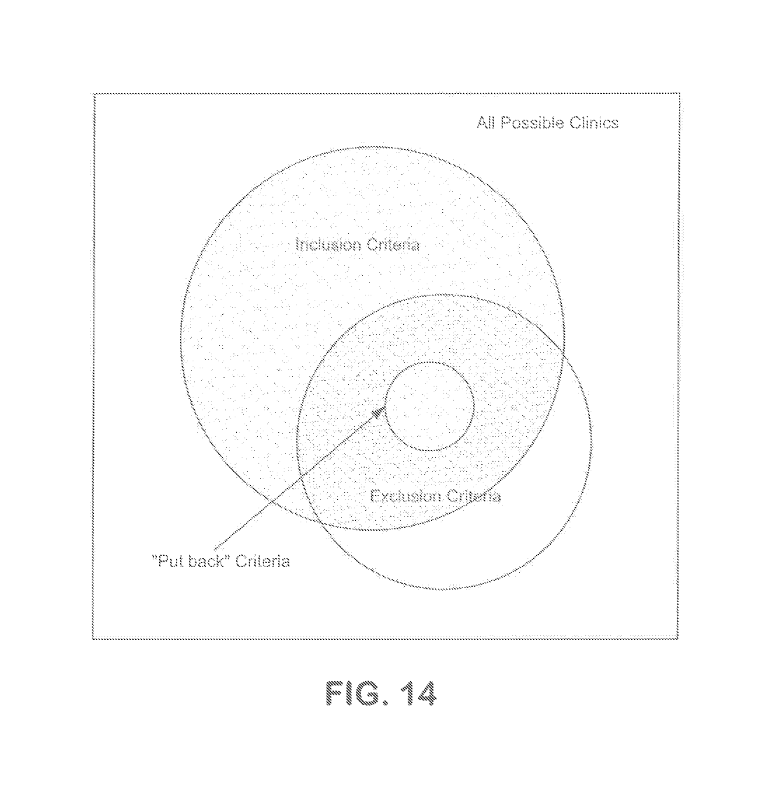

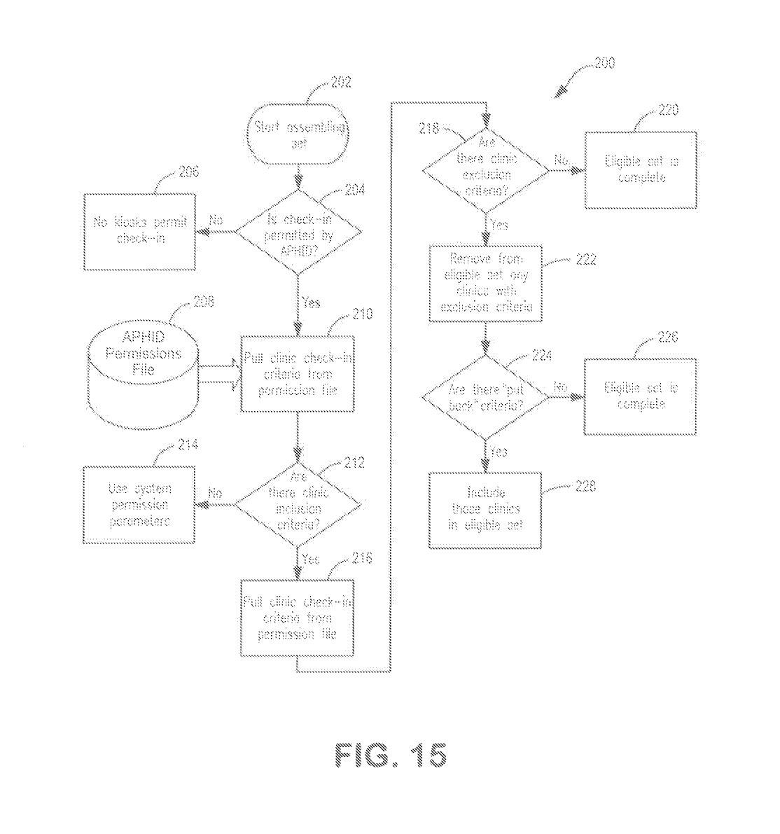

There may be situations where it is not desirable to permit clinic check-in from selected kiosks or kiosk locations. Consequently, the APHID system contains decision logic allowing system administrators to restrict check-in functionality to specific locations or clinic types. Using the APHID Setup executable, the administrator may use multiple criteria to build complex program logic and permissions. When the APHID setup executable is first installed, the administrator keys must be assigned to hospital personnel in VistA. Users with administrator keys can update business rules to align with the local clinic workflow processes. As shown in FIG. 14, the administrator assembles business rules using specific criteria (e.g. clinic name, division name, kiosk IP address, clinic stop codes, or specific string text within the clinic files) and Boolean operators. These business rules, called parameters, provide inclusion and exclusion criteria that can be applied each time a patient attempts to use the kiosk. For example, the APHID system can be configured to allow check-in only for one clinic, several designated clinics, or all clinics associated with a facility. Furthermore, if the system administrator configures the APHID system to run for all clinics, department administrators can still customize access and function or opt out at the kiosk level. This is especially useful for settings where multiple disparate clinics with different workflow processes or check-in expectations receive patients in the same physical area. For example, certain specialty clinics may wish to only use the check-in function or a selected array of clinical modules, or alternatively, some clinics may elect to forgo using the APHID system altogether.

The parameters may be stored in a MUMPS parameter file, and can then be applied to a single kiosk, an array of kiosks associated with a clinic, kiosks with specific IP addresses, or all kiosks deployed throughout the facility. In order to consistently apply specific business rules to each kiosk, support personnel must assign a static IP address to each workstation. At the time of kiosk deployment, the system administrator can accept system defaults or enter parameters associated with the new IP address. As shown in FIG. 15, the settings are then stored in a permissions table or file located on the VistA server. The table enables the administrator to associate a specific appliance with a division title, clinic name, physical location, or network printer. Each time the APHID executable runs, permissions associated with the IP address are retrieved and checked by the APHID system logic. When conflicting business rules are applied to overlapping arrays of kiosks, the software applies a hierarchical logic to resolve conflicts.

The setup program allows the administrator to set a variety of options for routing of data output. For example, the administrator may indicate VistA MailMan addresses for directing demographic and billing updates input by the patient. Other options include configuration of the patient identity authentication function and activation or deactivation of the clinical modules. The remaining levels (kiosk and clinic) are where division restriction, a late check-in feature, a check-in only option, and a printing function is identified. Individual or groups of kiosks can also be set to accommodate a touch screen, card swipe, and phone.

In further detail, referring to FIG. 15, functional module 200 commences set assembly at location 202. At location 204, module 200 verifies if check-in is permitted by APHID, and if the verification is negative, no kiosks permit check-in at location 206. If the verification at location 204 is positive, clinic check-in criteria are retrieved from permissions file 208 at location 210. Thereafter, at location 212, module 200 verifies if there are clinic inclusion criteria, if no, module 200 uses system permission parameters at location 214, and if yes, module 200 retrieves the clinic check-in criteria from permissions file at location 216. At location 218, module 200 verifies if there are any clinic exclusion criteria, if not, then the eligible set is complete at location 220, and if yes, any clinics with exclusion criteria are removed from the eligible set at location 222. Finally, module 200 verifies if there are any “put back” criteria at location 224, if not, then the eligible set is complete at location 226, and if yes, any clinics in the eligible set are included at location 228.

Printer Preferences

The APHID system supports a variety of data output modalities including hard copy. Paper documentation in many cases provides the greatest flexibility and portability at the point-of-care. The system administrator can set certain kiosks, locations, or clinics to automatically print part or all of the information captured at the kiosk. Additional information is included that would otherwise be collected through a human interaction. If the patient has a behavioral flag, a specific string of text will print in the middle of the printout. If a patient indicates new insurance information on APHID, the printout will signal clerical staff to obtain a copy of the patient's insurance card.

Eligibility Criteria

Patients that have not been vetted by the medical center are not eligible to receive non-emergent medical care since medical centers may not be reimbursed for services rendered. Hence, some facilities have implemented policies to catch and refer non-vetted patients to a local enrollment office. The APHID system includes a functional module that assists with this task by performing a basic eligibility check. When the patient attempts to check-in, the software checks an ineligibility field. If the field is flagged, the patient may not check-in. Instead, a screen message redirects the patient to an enrollment office.

Allergy Review

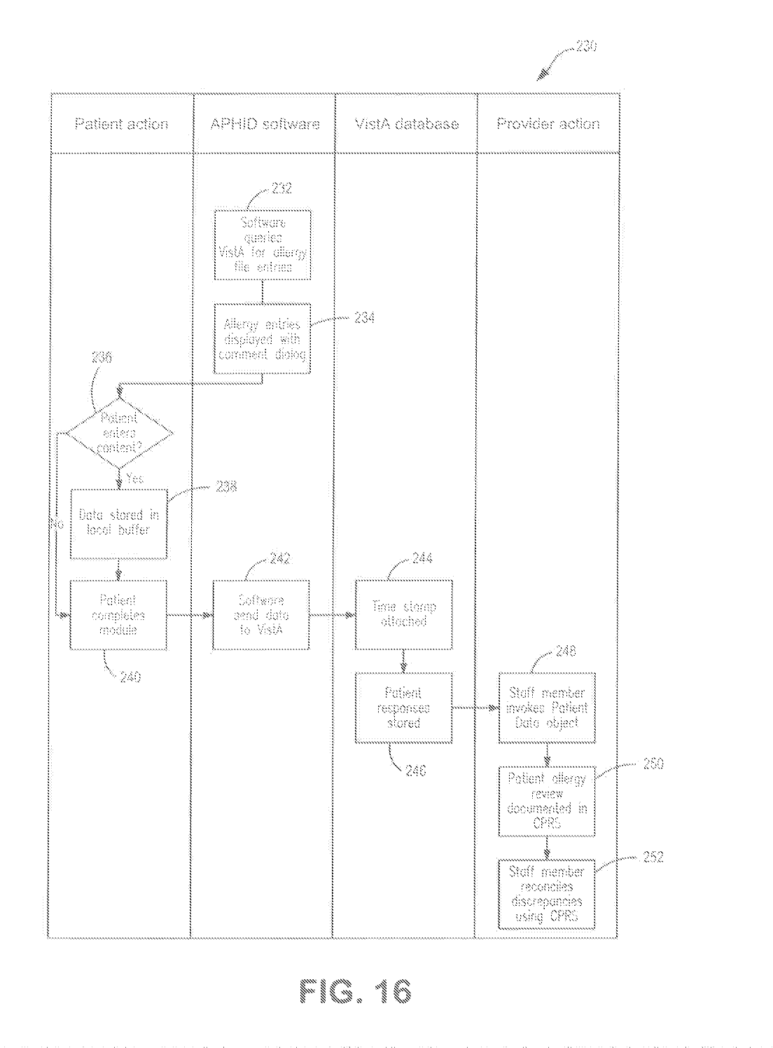

Referring to FIG. 16, allergy review module 230 allows the patient to review all allergies and adverse reactions listed in the VistA Allergy/Adverse Drug Reaction package. The information is a static list and cannot be directly updated, but corrections may be entered using a free text dialog.

In further detail, referring to FIG. 16, at location 232, module 230 queries VistA for allergy file entries, and at location 234, module 230 displays allergy entries with comment dialog. At location 236, module 230 verifies if the patient has entered content, and if yes, the data is stored in a local buffer at location 238 and then the patient completes the module at location 240. If the verification at location 236 is negative, then the patient completes the module at location 240, and then the APHID software sends the data to VistA at location 242. At location 244, a time stamp is attached, and at location 246, patient responses are stored. At location 248, a staff member invokes Patient Data Object, at location 250, patient allergy review is documented in CPRS, and at location 252, a staff member reconciles discrepancies using CPRS.

Medication Review

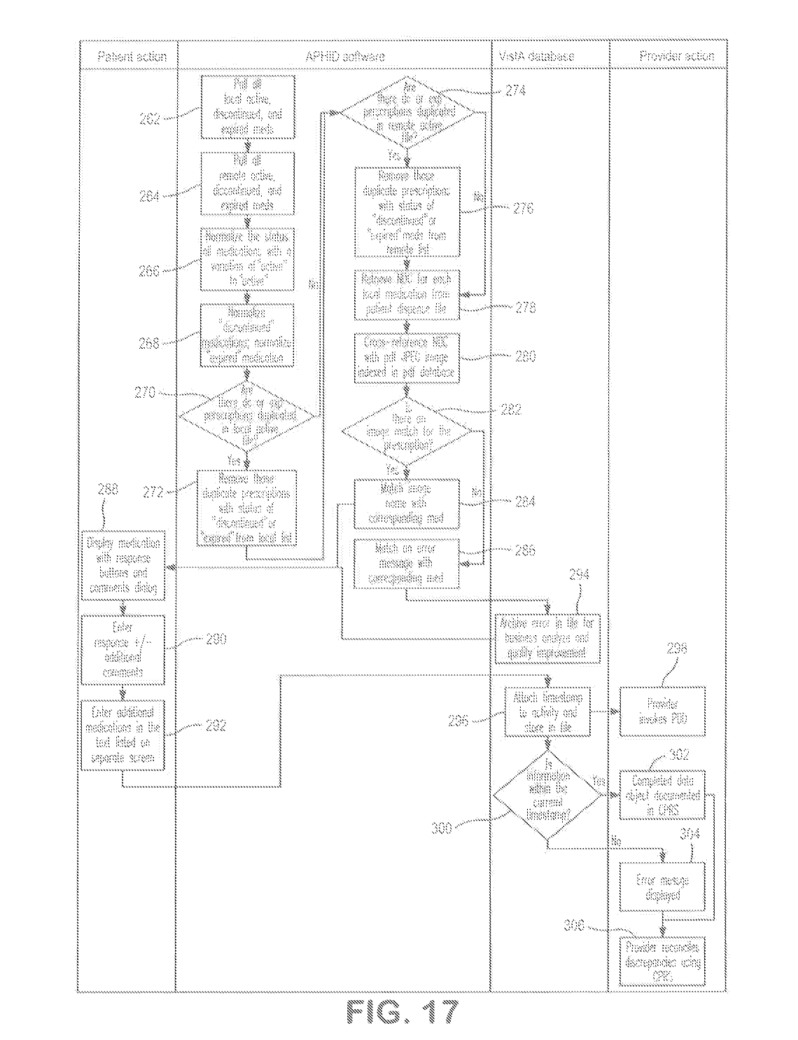

Referring to FIG. 17, the history program requires the patient to review a list of their current and recently expired\discontinued medications and identify any discrepancies. The active medication list, non-hospital medication list, remote hospital medication list, and, for example, six months of expired\discontinued medications are retrieved from the patient record. Display of expired\discontinued medications helps identify fugitive medications that the patient may still be consuming. Each prescription stored in the patient's dispense file has a corresponding unique national drug code (NDC) number assigned by the FDA. That number is cross-referenced with JPEG picture files stored on a local server, and APHID looks for the most recent prescription fill stored in the patient dispense file and uses the NDC assigned to that transaction. This business logic improves the precision of image matching and limits the probability of mismatched images caused by changes in pharmacy inventory. The image is paired with the medication name and displayed on screen. However, non-hospital medications and remote hospital medications cannot be matched with pictures at this time.

In further detail, referring to FIG. 17, the APHID executable logic 260 for matching pharmaceutical images with prescriptions is shown. Beginning at location 262, logic 260 pulls all local active, discontinued, and expired medications, at location 264, logic 260 pulls all remote active, discontinued, and expired medications, at location 266, normalizes the status of all medications with a variation of active to active, and at location 268, normalizes discontinued medications and normalized expired medications. At location 270, logic 260 verifies if there are discontinued or expired prescriptions duplicated in a local active file, and if yes, at location 272, logic 260 removes those duplicate prescriptions with status of discontinued or expired from a local list.

If the verification at location 270 is no, at location 274, logic 260 verifies if there are discontinued or expired prescriptions duplicated in remote active files. If the verification at location 274 is yes, at location 276, duplicate prescriptions with status of discontinued or expired are removed from remote list, and at location 278, NDC are retrieved for each local medication from patient dispense file. If the verification at location 274 is no, then logic 260 moves to location 278. At location 280, NDC is cross-referenced with pill JPEG images indexed in the pill database, and at location 282, logic 260 verifies if there is an image match for the prescription. If the verification at location 282 is yes, then logic 260 matches image name with corresponding medication at location 284, and if the verification at location 282 is no, then logic 260 matches an error message with the corresponding medication at location 286. At location 288, logic 260 displays medication with response buttons and comments dialog, at location 290, logic 260 enters responses and additional comments, and at location 292, logic 260 enters additional medications in a free-text field on a separate screen. At location 294, logic 260 archives errors in a file for business analytics and quality improvement.

Still referring to FIG. 17, from location 292, logic 260 moves to location 296 to attach a time stamp to activity and store in a file. At location 296, the provider invokes PDO, and at location 300, the information is verified to be within the current timeframe. If the verification at location 300 is positive, then completed data objects are documented in CPRS at location 302, and if the verification at location 300 is negative, then an error message is displayed at location 304, and then the provider reconciles discrepancies using CPRS at location 306.

Performance Characteristics and Quality Assurance

The APHID system accommodates a broad range of patient and clinician users in a range of ambulatory settings. User-centered design (USD) techniques including usability testing, workflow analysis, and rapid-cycle prototyping are applied throughout the lifecycle. Quality assurance metrics can address three major goals: demonstrate software quality in advance of deployment, provide facilities with suggested dashboard measures for post-implementation process monitoring, and inform future product design enhancements to manage the root cause of medication errors. The following description provides a brief overview of system performance characteristics.

Referring to Table II, a variety of metrics are applied to assess performance including, for example, system reliability, software usability, organizational compliance, and software accuracy, and metrics may assembled in a tiered hierarchy.

TABLE II
Tiered Metrics Used to Measure Reliability and Effectiveness of APHID

| Tier | Expectation | Measure | Source/Methodology |
|---|---|---|---|
| Technical | Infrequent downtimes | # days between downtimes | Clerical incident reports |
| performance | Fast system response time | Data load time per page | pending |
| | Picture matching rate | # missing pictures over total # | Software error log |
| | | of unique candidate meds/day | |
| | High patient-kiosk utilization | Proportion of check-ins | FileMan query of appt files |
| | | completed with kiosk | |
| Software | Patient satisfaction | Patient usability scores | Patient usability surveys |
| usability | Rapid patient transactions | Cycle times | Cycle time at terminals |
| | Provider acceptance | Provider feedback reports | Provider focus groups |
| Organizational | Patients checked-in for clinic at | Maximum predicted patient | Queueing prediction models |
| integration | a rate that limits wait time | check-ins per terminal per hour | |
| | Uniform collection of targeted | Proportion of encounters with | Automated chart review using |
| | information | complete note documentation | text parsing software |
| | FTE neutral utilization | FTE allocation tracking | FTE prediction models |
| Data accuracy | High validity of medication data | Accuracy of medication data in | # of medication discrepancies |
| and clinical | collection | comparison to gold standard | in comparison to gold |
| safety | | | standard |
| | High validity of business data | Accuracy of administrative | Number of data corrections |
| | collected | data | entered by staff |
| | Improved or equal efficacy of | Frequency of provider action | # of provider changes per visit |
| | clinical information collection | | measured with chart review |
| | Information improve clinician | Provider efficiency of history | Cycle time and accuracy of |
| | data retrieval at next encounter | collection at next encounter | medication history |

Technical Performance

Technical performance is a measure of system response time and kiosk availability in a production environment. Several metrics assess APHID technical performance including, for example, days between system downtime, proportion of medications with picture available, the time for page data to load to screen, and the proportion of candidate encounters checked-in using the APHID system.

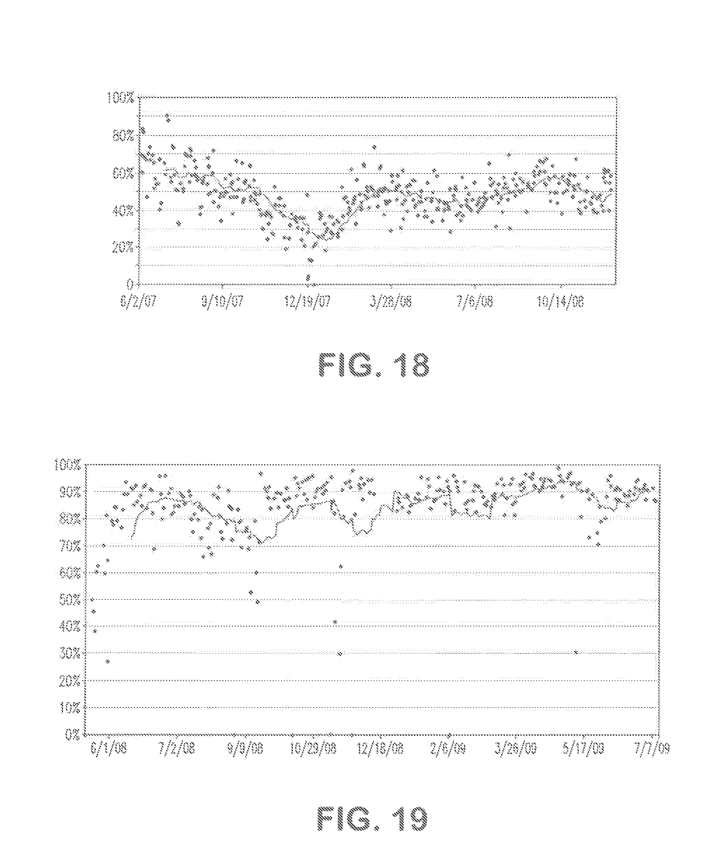

The inventors herein have tested the APHID system by monitoring performance statistics in a production environment and tracked the number of operational business days, the total number of appointments checked-in per business day, and the proportion of scheduled appointments checked-in each day using the APHID) system. In a given time period, the system has been functional over 99% of the time, with the majority of downtimes being associated with facility LAN failures or VistA down times. As shown in FIG. 18, between 50-60% of all primary care clinic appointments check in using the software, whereas as shown in FIG. 19, approximately 95% of specialty care clinic appointments check in using the APHID system.

Software Usability

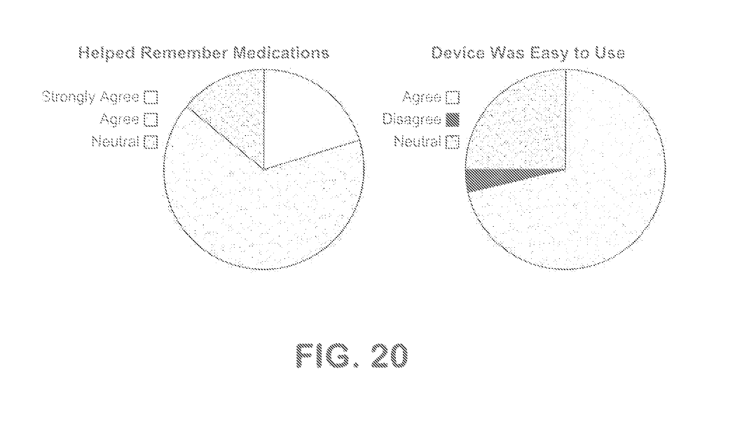

Software usability is a measure of interface clarity and the ability of the interface to meet functional goals. The patient-directed interface was developed by testing a series of prototypes with patients and collecting data through non-participant observation (e.g. scenario-based USD). A stable beta product was then loaded into production for testing with a primary care population. During this phase, patients were asked to evaluate the product using a previously published and validated usability survey developed at IBM. As shown in FIG. 20, the APHID system received high marks on patient usability and learnability scales. Of note, preliminary use statistics showed that elderly patients were able to use the technology, as shown in Table III, clinical characteristics of the user population were collected to assess cycle time and help predict clinic throughput.

TABLE III
Characteristics of Patient Check-in Encounters

| | | Mode | Range | N |
|---|---|---|---|---|
| Mean patient age in years (sd) | 60.8 (14.1) | | 21-93 | 1371 |
| Average time in minutes at | 4.5 (3.0) | 2.1 | 0.6-36.6 | 1371 |
| kiosk (sd) | | | | |
| Average time at kiosk when | 6.3 (3.9) | 4.4 | 1.6-37 | 309 |
| adding new medications | | | | |
| Average time at kiosk when only | 4.0 (2.4) | 2.1 | 0.8-21.3 | 938 |
| reviewing medications | | | | |
| Average number of medications | 8.0 (6.3) | | 0-51 | 1371 |
| reviewed | | | | |
| Average number of medications | 2.3 (2.1) | | 1-14 | 373 |
| added | | | | |

Organizational Integration

Organizational integration and functional performance denotes the ability of the APHID system and associated business processes to fulfill organizational goals (e.g. medication reconciliation compliance standards). Performance metrics for the product should reflect similar standards uses by external agencies such as the hospital External Peer Review Program (EPRP) or the Joint Commission (JC).

For this reason, as shown in Table IV, metrics used to measure APHID performance closely maps to JC standards for medication reconciliation (JC National Patient Safety Goal 8).

TABLE IV
Table of Performance Metrics for Organizational Compliance

| Task | Joint Commission | EPRP Proposed Metric | APHID Metric |
|---|---|---|---|
| 1 | Complete list of | Documentation of | Proportion of |
| | patient medications | patient furnished list | visits with PDO |
| | documented | collected | documented in chart |
| 2 | Medications on file | Documentation of VA | Proportion of visits |
| | for patient are com- | list with name, dose, | with PDO |
| | pared to patient | route, frequency and | documented |
| | furnished list | that discrepancies were | |
| | | identified | |
| 3 | Discrepancies are | Evidence that list was | Average number of |
| | reconciled and | reviewed with patient | discrepancies per |
| | documented | and medication | case |
| | | changes made | |
| 4 | Patient is furnished | Evidence that changes | Proportion of |
| | with a reconciled | were reviewed with | patient visits |
| | list | patient and patient | summary list |
| | | was given written list | distributed |

These metrics provide a template that medical organizations may use to monitor APHID performance and organizational adherence to national quality standards. In general, clinics that used the APHID check-in software and documentation process were 100% compliant with documentation of tasks 1 and 2 in Table IV.

Data Accuracy and Safety

Reconciliation accuracy denotes the ability of the APHID system to correctly capture the medication compliance history of a patient. In this regard, the interface tool is analogous to a diagnostic test. As shown in Table V, the performance characteristics of a diagnostic test are typically defined in terms of sensitivity and specificity.

TABLE V
Measuring the Accuracy of a Medication History Tool

| | True consumption patterns | | |
|---|---|---|---|
| | Patient does not | Patient uses | |
| | use medication as | medication as | |
| | prescribed | prescribed | |
| Survey tool | True positive for | False positive for | TP + FP |
| indicates | medication | medication | |
| patient does | discrepancy (TP) | discrepancy (FP) | |
| not take | | | |
| medication as | | | |
| prescribed | | | |
| Survey tool | False negative for | True negative for | FN + TN |
| indicates patient | medication | medication | |
| takes medication | discrepancy (FN) | discrepancy (TN) | |
| as prescribed | | | |
| | TP + FN | FP + TN | Total |

where:
TP/TP + FN = Sensitivity
TN/TN + FP = Specificity
TP/TP + FP = Positive Predictive Value
TN/TN + FN = Negative Predictive Value

Sensitivity can be defined as the proportion of real discrepancies identified by the device over all discrepancies, both identified and missed. Specificity may be defined as the proportion of medications reviewed without identified discrepancies over all medications prescribed that the patient takes according to instruction.

Currently, data is gathered in a randomized, controlled, and blinded setting to calculate the sensitivity, specificity, positive predictive value, and negative predictive value of the patient-entered medication history. To properly measure a screening test such as the APHID system, it is necessary to compare the results of the tool against a recognized and validated gold standard. In the case of medication reconciliation, the gold standard for assessing compliance is a structured clinician-conducted medication interview. As shown in Table VI, preliminary data collected from patient cases monitored in, for example, the Portland hospital Chemotherapy Infusion clinic indicate that the reconciliation software is more accurate than most standard-of-care reconciliation tools used in US healthcare systems.

TABLE VI
Discrepancies Identified by APHID and Confirmed through Chart

| | | | % of errors | |
|---|---|---|---|---|
| Class of | | Average | per total | % of patient |
| medication | | # per | medications | cases with |
| discrepancy | Total # | visit | prescribed | discrepancy |
| Potentially lethal | 3 | 0.03 | 0.2 | 3.4 |
| Significant | 139 | 1.58 | 9.8 | 70.5 |
| Insignificant | 262 | 2.98 | 18.5 | 83.0 |
| Total | 404 | 4.59 | 28.5 | 90.9 |

Over 90% of patient cases reviewed using APHID revealed one or more medication discrepancies when compared to the CPRS list and over 70% had a clinically significant medication documentation error. In an embodiment, the Portland Oreg. Patient Safety Center of Inquiry (Portland PSCI) in collaboration with the National Center for Patient Safety (NCPS) is currently studying the performance characteristics of the APHID reconciliation tool in a randomized controlled trial. The output of each arm is compared to a gold-standard history, and the results of this study will help to estimate the accuracy of reconciliation tools like APHID and help developers identify the root-causes of medication errors.

Software Quality Assurance

The APHID system architecture conforms to published software conventions and standards endorsed by the Office of Enterprise Development (OED) in the Office of Information and Technology (OIT). The software has been reviewed and certified by the Office of Enterprise Operations (OEO) in Off. By adhering to universally approved programming standards, the APHID system is portable (e.g. it may be installed in any standard hospital facility implementing VistA) and extensible (e.g. the software can be configured for any size hospital facility). The following description provides an overview of the standards applied and steps taken to ensure OI&T certification.

MUMPS Standards and Conventions

The APHID system is in part, comprised of MUMPS code including new VistA files, data entities, patient data objects, and remote procedure calls. All MUMPS elements meet OED standards and conventions published in the Standards and Conventions (SAC) manual. Furthermore, the MUMPS code has been peer-reviewed by the Region 1 Service Line for Application Development and is certified compliant with IT Field Development standards.

Graphical User Interface Object Pascal Software Standards

The patient-facing interface and administrator setup utility executable use a Delphi GUI. All Delphi (Object Pascal) elements associated with the APHID and Setup executables adhere to GUI standards published by OED. Furthermore, the code has been peer-reviewed by the Region 1 Service Line for Application Development and is certified compliant with IT Field Development standards.

Privacy and Security

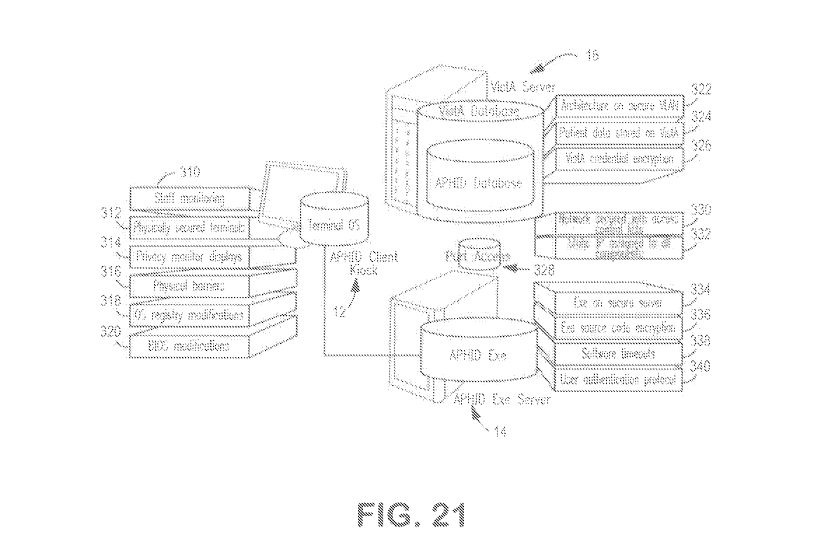

Privacy and security are of paramount importance in the healthcare setting. The Health Insurance Portability and Accountability Act (HIPAA) federally mandates hospitals, health care providers, and private practices to adhere to strict privacy and security regulations on patient information. Hence, the APHID system is designed to meet the strictest Information Security Office (ISO) security requirements and HIPAA patient privacy requirements. Although any system can be compromised given sufficient investment of time and resources, as shown in FIG. 21, a goal for the APHID system development was to make it as difficult as possible for a persistent attacker to compromise the integrity of the system architecture. The following description details exemplary measures implemented to address privacy, security, and authorization.

Referring to FIG. 21, generally, at APHID kiosk 12, privacy and security are provided by staff monitoring at location 310, physically secured terminals at location 312, privacy monitor displays at location 314, physical barriers at location 316, OS registry modifications at location 318 and BIOS modifications at location 320.

For VistA server 16, privacy and security are provided by architecture on secure VLAN at location 322, patient data being stores on VistA at location 324 and Vista credential encryption at location 326.

For port access at location 328, privacy and security are provided by the network being secured with access control lists at location 330, and static IP assigned to all components at location 332.

For APHID server 14, privacy and security are provided by execution on a secure server at location 334, execution of source code encryption at location 336, software timeouts at location 338, and user authentication protocols at location 340.

The aforementioned privacy and security protocols will now be described in detail.

Privacy

Privacy refers to the control and disclosure of protected health information. The APHID kiosk architecture was developed in cooperation with regional and national hospital privacy officers to ensure that the system meets privacy regulations specified by VHA, OI&T, and HIPAA. It was necessary to include features in the software and hardware to limit unauthorized display or disclosure of patient data, with exemplary steps taken to protect users being listed below.

Timeouts

Each page of the executable may include a timeout feature, such that each page will timeout after, for example, 70 seconds of inactivity and display a warning window. If the user fails to respond to the warning, the software closes and restarts a new session. Timeouts reduce the likelihood of an unauthorized individual attempting to use an open session after a patient abandons a kiosk mid-transaction. This type of intervention protects records against deliberate or inadvertent disclosure.

Physical Configuration

Since the kiosk software requires the input and display of sensitive information, it is important to ensure that patients feel comfortable using the device. To that end, several considerations should be given to the physical installation of client terminals. For example, first, monitors should be fitted with privacy filters (typically polarized screens) that confine the field of view. The self-service industry offers a myriad of privacy monitors with touch-responsive capabilities. Second, physical barriers such as wings, solid flaps, or workstation carrels should be installed to shield the monitor and patient activities from prying eyes. Third, terminals should be installed in locations that are within sightline of dedicated staff such as medical assistants, customer service representatives, or greeters.

Data Theft Deterrence

The APHID system can be configured to permit printing of summary sheets. These sheets may contain patient identifiers or responses to the medical survey modules. This documentation can be used as a clinic triage and routing document or as a point-of-care reference for clinic staff. Alternatively, information can be furnished to the patient as a reference document or proof-of-encounter. Printed documentation used by clinic personnel can only be routed to networked printers designated by the system administrator at the time of software installation and configuration. Therefore, it is crucial that clinic printers are placed in secure clinic locations, and it would be the responsibility of clinic staff to dispose of documentation not furnished to the patient.

Security

Security is the administrative and technical measures taken to protect patient privacy. Security measures have been included to satisfy VHA, OI&T, and HIPAA security regulations. Facility and regional information security officers have provided expert consultative guidance on the final design. Furthermore, a series of assessments and penetration tests were conducted for Region 1 ITFD certification.

Physical Security

No data is ever stored on the client device, and client devices should be physically bolted or locked to clinic furniture, reducing the likelihood that a device would be physically removed. Nonetheless, if a user walks away with a terminal and removes the flash drive or hard drive, no patient data will be available.

Strong User Verification Methods

Redundant systems are embedded in the system login to authenticate patient identity. First, the patient must initiate a client session by swiping a Patient's Identification Card using an attached magnetic stripe reader. Second, the patient must verify their identity by completing, for example, a challenge question such as keying in their social security number. If the patient does not have an identification card, the patient can complete, for example, two complementary challenge questions such as entering a social security number and birth date. Third, information is only accessible on business days with a scheduled appointment. If an individual attempts to access information without an appointment, the APHID system re-directs the user to a customer service representative. If the patient attempts to use the terminal after an appointment is checked-in or cancelled, the software re-directs the user to a customer service representative. This intervention reduces the probability of unauthorized access when the patient is not on campus.

Network Access

The APHID kiosks are pre-configured to run in a lock down mode where users do not have access to any functionality beyond the APHID system. A network service account enables client workstations to connect with the network and access the APHID server. The account may include the credentials to authenticate with the network domain and connect with the APHID server. Several strategies prohibit unauthorized access to account credentials or network domains. First, the kiosks are logged onto their own user group with a unique profile. The profile has been configured with minimal permissions and will only allow the client to run the APHID GUI. All other applications, desktop settings, network resources, and terminal functions are unavailable to the end-user. The profile may include a standard login protocol to ensure transparent network connectivity. The APHID application itself does not allow the user to access the operating system, storage media, or any other administrative applications. The application does not offer web browser or file manger functionality. When a patient has completed the check-in survey, the application restarts automatically.

The entire architecture is assembled on a closed VLAN located on the facility network and within the facility firewall. Network traffic is tightly regulated by ACLs applied to the network switch. This configuration limits user capabilities, network vulnerability, and data packet loss.

VistA Connectivity

Each time a patient uses the APHID system to retrieve health information from the electronic record, the APHID system passes dedicated VistA account credentials to the host application. The login credentials cannot be viewed by the end user and can only be changed by a programmer with VistA XUPROGMODE KEY access. The credentials are encrypted and will not work properly if the executable is decompiled. The account is equipped with the minimum set of menu options needed to complete program tasks and retrieve data used by the application. Data packet exchange between client application and VistA exchange server occur over existing physical layer network connections behind the hospital firewall.

Client Terminal Access and Functions Must be Restricted

To accommodate a variety of facility support expectations, it is necessary to create several user profiles with different permissions. Two user types were identified: patients and technology administrators. Patients can only interact with the client terminal using the APHID GUI, and all patient interactions begin with the patient authenticating their identity by swiping their ID card and entering corroborating information via keystroke. Kiosk access is denied by the application business logic if the patient enters invalid or mismatched identification data. Technicians and network administrators will also need to access administrative applications on the client. Appropriate accounts for corresponding systems can be distributed to individuals with administrative and support responsibilities.

Accountability

Accountability refers to an enterprises role in tracking access and use of protected health information. Several measures should be incorporated into a facility's installation strategy to address issues of information auditing.

Arrange for Continuous Hardware Monitoring

Workstations must be continuously monitored by administrative staff during business hours. Clerical personnel should be available to assist patients with software usability barriers and administrative tasks that cannot be handled by the self-service kiosk. Furthermore, the physical proximity of support personnel would simultaneously discourage inappropriate computer use and the inherent risk of hardware or data theft. Two strategies may be used to meet this monitoring need. First, workstations should be installed in common workflow areas where clinical and administrative personnel are likely to be present. Second, clerical proctors should be detailed to kiosk supervision. The number of necessary clerical personnel would be dictated by the clinic setting and expected customer throughput.

Plan for a Network Monitoring Protocol

Data auditing processes are needed to support threat assessment and risk management. Specifically, data auditing reports may be run on a monthly, quarterly, or biannual basis. Duration and location of all account activity and data exchange would be retrievable. Furthermore, network activity may be correlated with VistA data exchange to determine what health information was retrieved for any given interval.

Implementation Strategy Overview

The APHID system is designed to support users and automate selected steps of the check-in and medication review process. However, care must be taken to consider the target environment before configuring new technology. In certain circumstances, the workflow may need to be re-engineered to ensure a successful implementation. It is important that users of the APHID technology carefully examine the current business processes, policies, and staff expectations, considering any potential organizational misalignments. The following description provides an exemplary overview of the implementation.

Kiosk technology is relatively new in healthcare, and hence, case studies assessing organizational change are limited. However, there is an extensive cannon of informatics literature attesting to the role of organizational behavior on the relative impact of new technology. There are many reports of health record systems, healthcare devices, or decision support modules failing due to the inability of enterprise leadership to understand existent system design, workflow patterns, organizational culture, and clinician behavior. Many of the common principles applied to health record implementations can inform kiosk installations. Furthermore, several themes unique to kiosk installations have also emerged from early industry research.

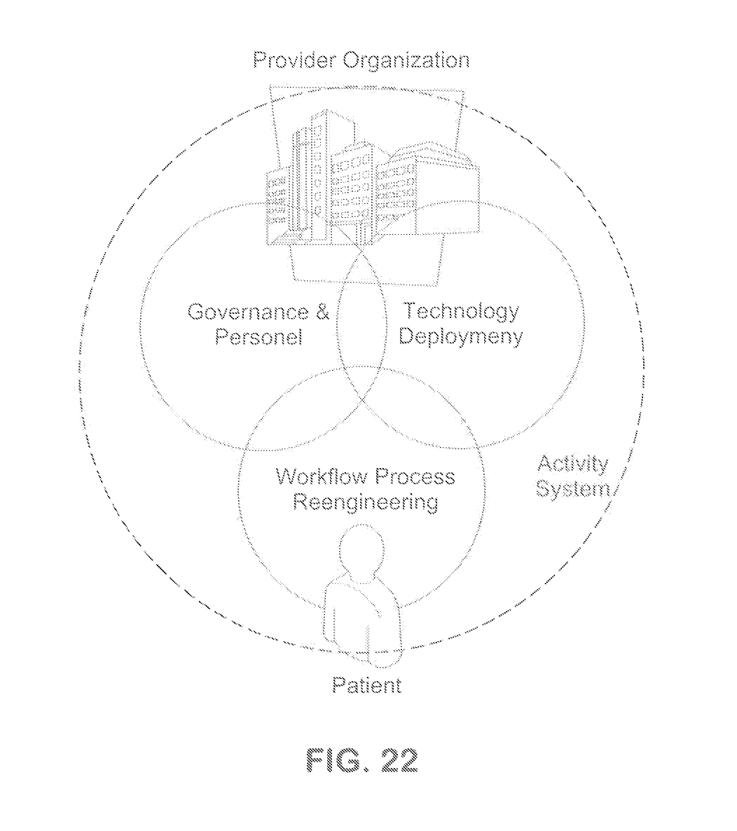

Standing up a kiosk architecture creates a new activity system. An activity system may include actors, processes, tools, artifacts, and their physical environment, and is organized around a goal-directed activity. As shown in FIG. 22, the activity system may be organized, for example, into three basic domains: governance and personnel, technical deployment, and process reengineering. Stakeholders and business owners need to address each domain in order to successfully implement a self-service system. The following description outlines a set of guiding principles and best practices associated with each domain that can help facilities installing APHID.

Deployment

In order to encourage patient participation and optimize system use, business stakeholders must think of kiosks as product offerings, in that patients will not necessarily avail themselves of the services offered by a kiosk without encouragement. For this reason, it is important to consider strategies to market the kiosk. Strategies may include kiosk placement, the use of signs, optimized workspace configuration, privacy protection, clinic prioritization, staff participation, and dedicated personnel.

Workflow

The inventors herein have recognized that the most durable system-based interventions are distributed over several members of a multi-disciplinary care team. This helps to balance workload, reduce single failure points, provide a nominal amount of redundancy, and engage all team members in a shared goal. By combining the process to all aspects of the clinical workflow or supply-chain, a common view that people and processes are tied together with system performance and organizational goals is cultivated.

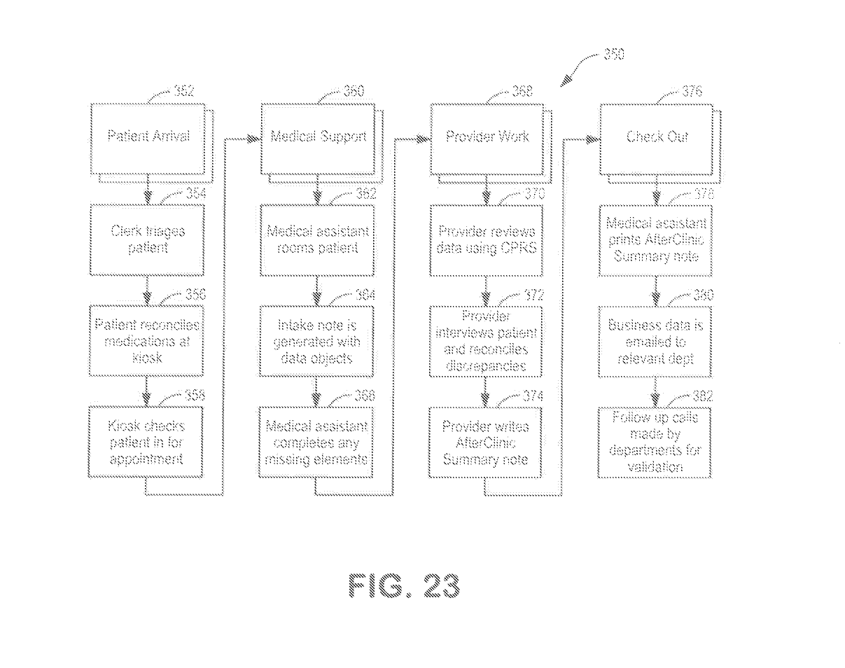

Referring to FIG. 23, an exemplary workflow model 350 for a typical primary care clinic is outlined. In this model, kiosk workstations are located in the clinic lobby and common areas. Signage and clerical support direct patients to kiosks to begin the check-in process. Clerical personnel are available throughout the check-in process to proctor workstations, troubleshoot errors, assist patients, and direct foot traffic. The setting is analogous to airline check-in booths located at airport terminals. Medical assistants and clinical support personnel room patients after they have checked-in. During the rooming process, clinical support personnel generate a TIU document (e.g. Primary Care Intake Note), which contains the APHID PDO as a component of a larger boilerplate. Clinic personnel can then confirm or clarify any data furnished by the patient and update the note as required. The clinic staff is encouraged to enter non-hospital medication information into the non-hospital medication package at this time. Upon completion of the intake process, clinical providers are notified of the patient's status and are given the opportunity to review the documentation in advance of the clinical encounter. During the interview, providers are encouraged to change, renew, add, or discontinue medications in order to reconcile medication lists. At the conclusion of the clinical encounter, the provider can generate an After Clinic Note or direct a clinical support staff member to generate the note and distribute to the patient.

In further detail, referring to FIG. 23, for the exemplary workflow model 350, at location 352, upon a patient's arrival, a clerk triages the patient at location 354. At location 356, the patient reconciles mediations at the kiosk, and at location 358, the kiosk checks the patient in for the appointment. At location 360, medical support is provided by a medical assistant rooming the patient at location 362, and an intake note is generated at location 364. At location 366, the medical assistant completes any missing elements, and at location 368, for provider work, the provider reviews data using CPRS at location 370. At location 372, the provider interviews the patient and reconciles discrepancies, and at location 374, the provider writes an AfterClinic summary note. At location 376 for check out, at location 378, the medical assistant prints the AfterClinic summary note. At location 380, the business data is c-mailed to the relevant department, and at location 382, follow-up calls are made by departments for validation.

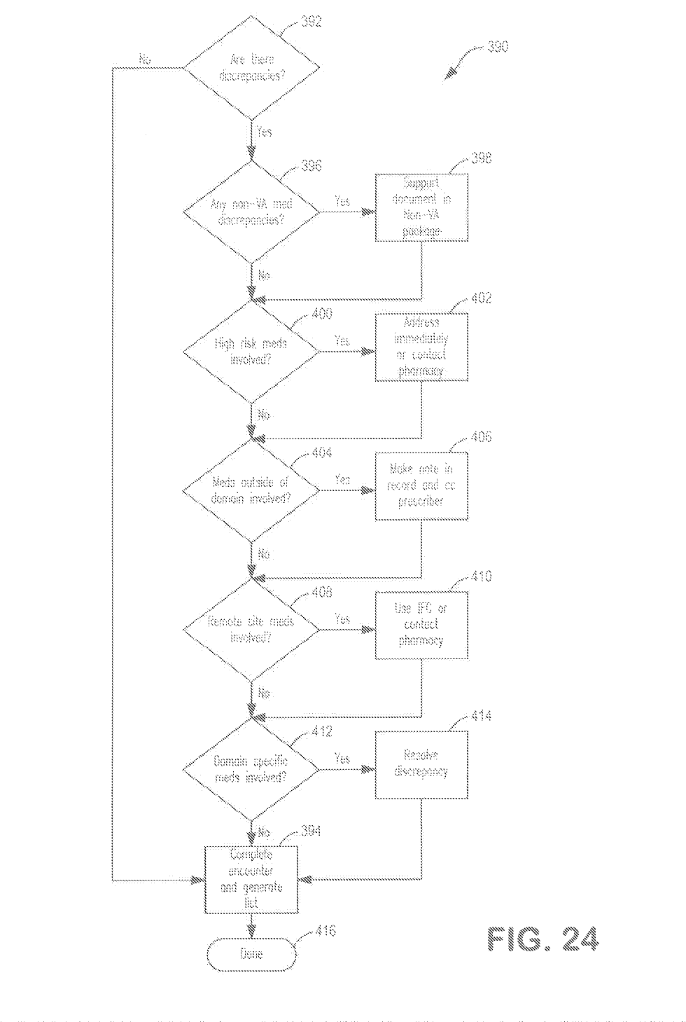

A similar workflow with slight modifications can be implemented for subspecialty, multidisciplinary and urgent care locations. Many subspecialty locations either share common clinic space or are situated far from the patient waiting area. It may, therefore, be necessary to configure the kiosks to trigger automated print-outs that contain crucial information including pre-registration directions, clinic locations, or additional pre-clinic instructions such as furnishing a blood or urine specimen upon arrival. Once the patient has checked in, the clinical support staff can collect the patient, direct to an exam room and generate an intake note with the embedded PDO. Since many providers in subspecialty care areas may not be the primary prescribers of medications and may not be positioned to safely intervene or adjust prescriptions, referring to FIG. 24, in these circumstances, decision heuristics and procedures should be well outlined as shown in the decision heuristics and procedures logic 390. For example, the providers may be directed to reconcile only those medications familiar to their domain of expertise and forward additional signer alerts to other providers as indicated. Alternatively, complex medication discrepancies or complex co-managed care errors (for example, a duplicate medication filled at two separate hospital facilities) may be directed to clinical pharmacists or dedicated practitioners to resolve.

In further detail, referring to FIG. 24, for the decision heuristics and procedures logic 390, at location 392, logic 390 verifies if there are any discrepancies. If the verification at location 392 is no, logic 390 completes the encounter and generates a list at location 394. If the verification at location 392 is yes, then logic 390 verifies if there are any non-hospital medical discrepancies at location 396 (note in the logic flow of FIG. 24, the example is provided for a VA hospital). If the verification at location 396 is yes, then logic 390 obtains a support document in a non-hospital package at location 398, and if the verification at location 396 is no, then at location 400, logic 390 determines if there are any high risk medications involved. If the verification at location 400 is yes, then logic 390 addresses the situation immediately or contacts a pharmacy at location 402, and if the verification at location 400 is no, then logic 390 determines if the medications involved are outside of the domain at location 404. If the verification at location 404 is yes, then logic 390 makes notes in the record and contacts the prescriber at location 406, and if the verification at location 404 is no, then logic 390 determines if any remote site medications are involved at location 408. If the verification at location 408 is yes, then logic 390 uses IFC or contacts the pharmacy at location 410, and if the verification at location 408 is no, then logic 390 determines if there are any domain specific medications involved at location 412. If the verification at location 412 is yes, then logic 390 resolves any discrepancies at location 414, and if the verification at location 412 is no, then logic 390 completes the encounter and generates a list at location 394, after which the logic process for decision heuristics and procedures is completed at location 416.

The general process for medication reconciliation, patient check-in and check-out, and intermediate processes of the APHID system will now be described in detail.

In order to check-in, referring to FIG. 8, a patient is directed to a kiosk and asked verify health information using the check-in program. As discussed earlier, kiosks are located in patient waiting areas and are equipped with APHID software that reviews the patient's contact information, billing information, allergies, and current medication list. Pictures of the medications are displayed to improve the accuracy of drug identification. Once check-in is completed, the patient can proceed to the waiting area.

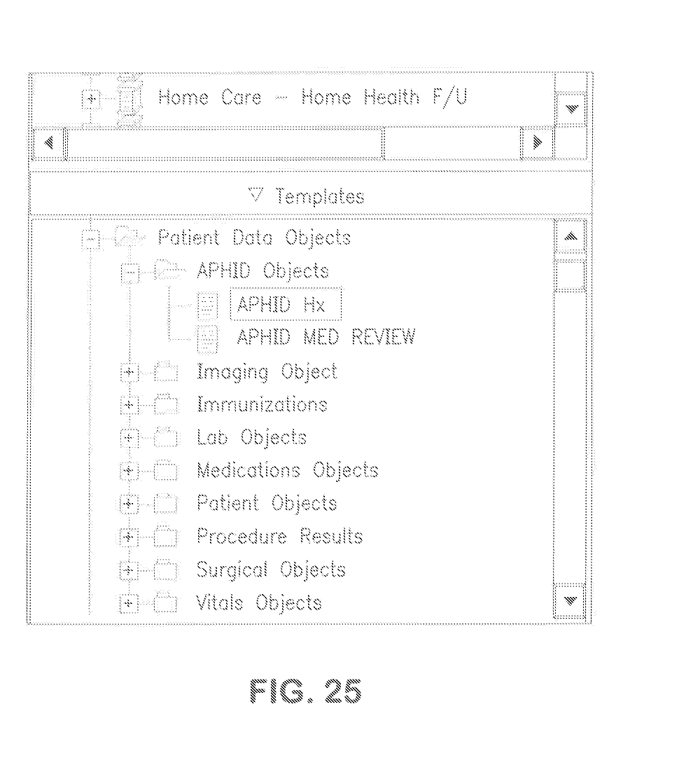

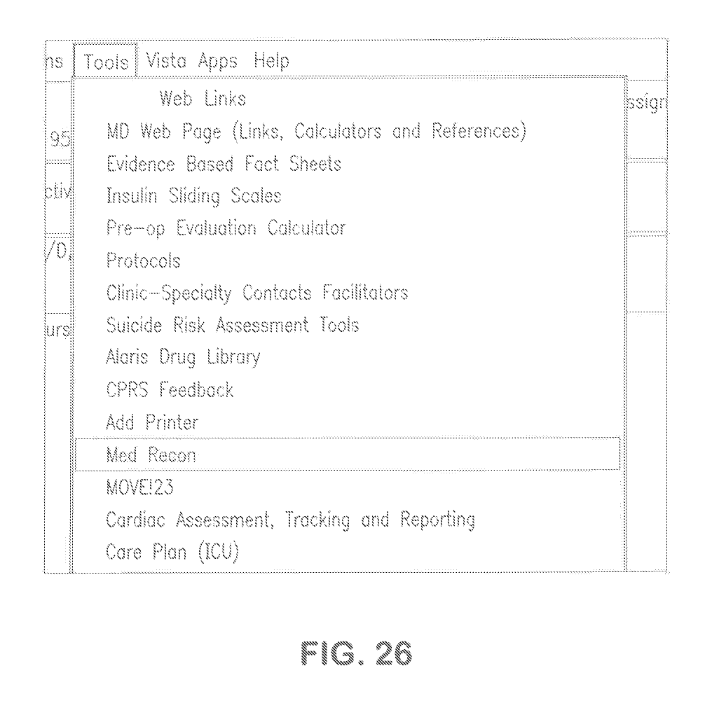

Referring to FIG. 25, the updated information is immediately available as a CPRS data object within Shared Templates→Patient Data Objects→APHID Objects→APHID Hx. If the patient arrives very near or after their scheduled appointment time, the APHID system will not review the medications. As shown in FIG. 26, if the patient doesn't review their medications at a kiosk, intake staff can review the patient's medications by using the Med Recon program located on the CPRS toolbar.

As discussed earlier, there should be support staff available at all times to help direct patients to check-in kiosks and to assist with questions. Referring to FIG. 25, once the patient has reviewed their medications using the kiosk or in discussion with intake staff, the data object is placed inside the intake note. Intake staff can add all new non-hospital medications to the non-hospital medication package. Intake staff can also review the list of medications and look for any high-risk situations that may require immediate intervention (e.g. multiple anticoagulants, duplicate active medications at a local and remote site, and irregular adherence to high-alert medications such as opioids, electrolytes, and anti-epileptics). Any high-risk situation should be brought to the attention of the clinic provider.

The provider is expected to review the medication history and update the medical record. If the nursing staff or provider elects to delete the adherence data from the note, a statement should be included to document that medications were reviewed. It is the provider's responsibility to update any medication orders during the visit or notify the responsible prescriber if indicated.

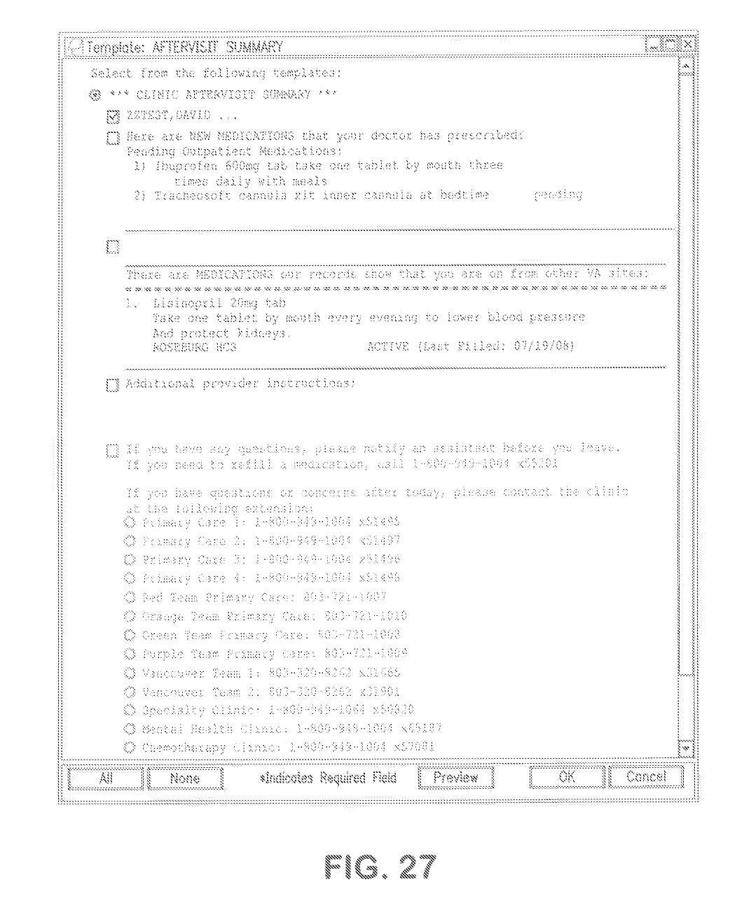

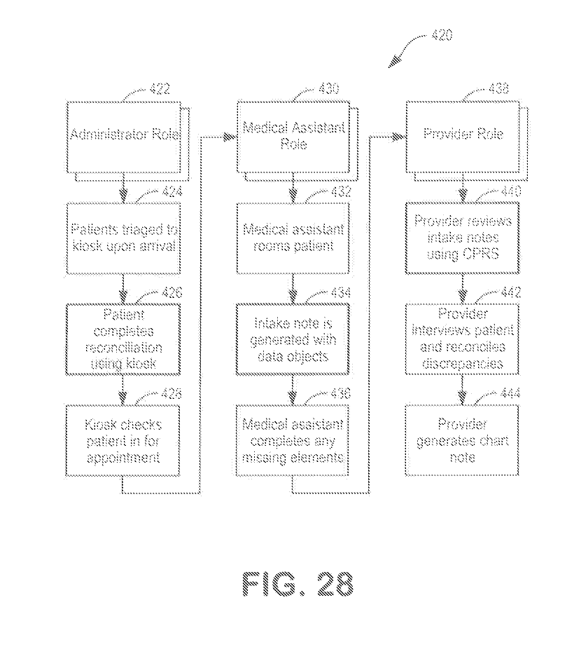

In order for the patient to check-out, the clinic must provide the patient with an updated medication list that displays both active and newly ordered medications prior to discharge from clinic. This must also be documented in the patient's medical record, and will serve as an education tool for both the patient and the next provider of service. Depending on your clinic setup, the provider or support staff can generate an Aftervisit Summary note. This is done by selecting the note title Aftervisit Summary and completing the template. The template will pull in future appointments, pending lab/imaging/consult orders, active, remote, pending, and newly discontinued medications, and contact information. As shown in FIG. 27, the provider can also insert any additional instructions. Nursing support, the provider, or clerical support should print this before departure (this document is desensitized and contains only the patient's name). Referring to FIG. 28, based on the above implementation, the workflow diagram of FIG. 28 shows an exemplary patient check-in/check-out strategy 420 using APHID system.

In further detail, referring to FIG. 28, for the exemplary patient check-in/check-out strategy 420, after location 422 at the administrative role, at location 424, a patient is triaged to a kiosk upon arrival. At location 426, the patient completes reconciliation using a kiosk, and at location 428, the kiosk checks the patient in for the appointment. After location 430 for the medical assistant role, at location 432, the medical assistant rooms the patient, and at location 434, an intake note is generated with data objects. At location 436, the medical assistant completes any missing elements. After location 438 for the provider role, at location 440, the provider reviews intake notes using CPRS, and at location 442, the provider interviews the patient and reconciles any discrepancies. Finally, at location 444, the provider generates chart notes.

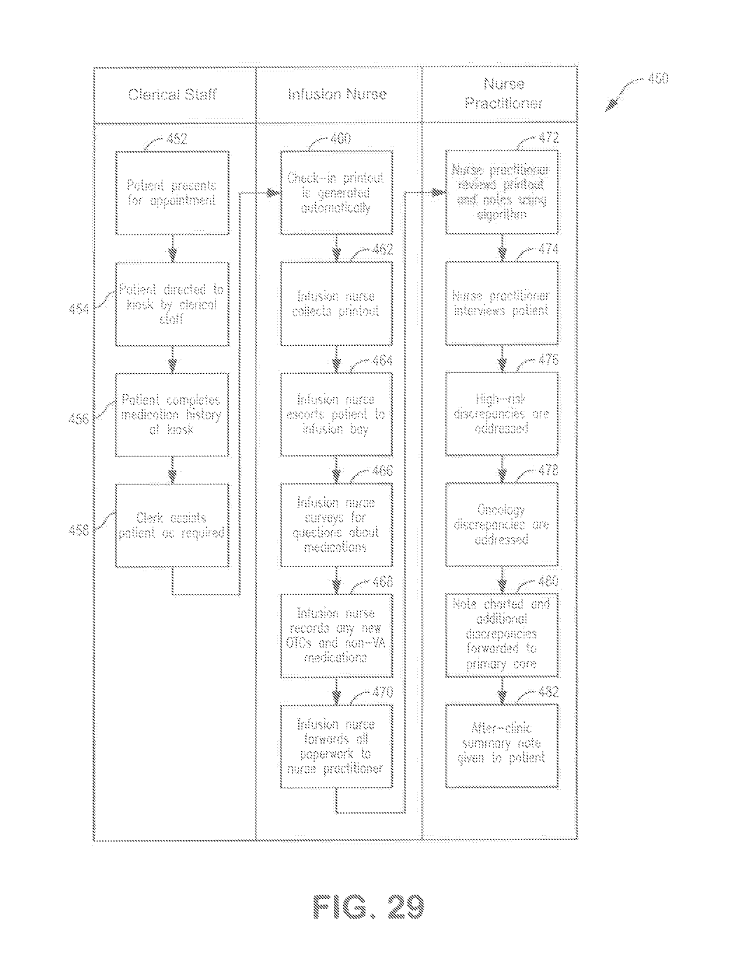

Referring to FIG. 29, an exemplary medication reconciliation, patient check-in and check-out process 450 for a chemotherapy patient is illustrated. As shown in FIG. 29, each patient would be directed to check into the clinic using an APHID kiosk and then to update his/her medication profile before the chemotherapy appointment. Data supplied by the patient would then be stored in the electronic health record (HER), and a printout including the patient's updated allergy and medication information would be generated, signaling to staff that the patient was ready for intake. The infusion nurse would collect the printout, escort the patient to a chemotherapy bay, and answer patient questions, recording any additional pertinent data on the printout, before forwarding to an nurse practitioner (NP). Referring to FIG. 24 and the discussion above, the NP would then review the list for discrepancies and triage the information according to a decision algorithm. The NP would first survey for discrepancies involving predefined classes of high-risk medications (e.g. hypoglycemics, narcotics, anticonvulsants, anticoagulants, and electrolytes). The staff would initiate a time out to address errors involving high-risk medications before the patient left the clinic. This may include changing the prescription, contacting the original prescriber, engaging an ancillary consultant, or providing education. Next, the NP would resolve any discrepancies associated with oncology medications. Any remaining discrepancies involving medications prescribed by other clinics or those outside the scope of oncology practice would be forwarded electronically to the primary prescriber using the EHR. Over-the-counter medications and neutraceuticals not supplied by the hospital would be recorded in the EHR by the infusion nurse. At the conclusion of the visit, the nurse practitioner or infusion nurse would print and furnish to the patient a templated EHR note that includes an updated list of all medications.

In further detail, referring to FIG. 29, for the exemplary medication reconciliation, patient check-in and check-out process 450, at location 452, a patient presents for an appointment. At location 454, the patient is directed to a kiosk by clerical staff, at location 456, the patient completes his/her medication history at the kiosk, and at location 458, the clerk assists the patient as required. At location 460, a check-in printout is generated automatically, at location 462, an infusion nurse collects the printout, at location 464, the infusion nurse escorts the patient to the infusion bay, at location 466, the infusion nurse surveys for questions about medications, at location 468, the infusion nurse records any new over-the-counter (OTCs) and non-hospital specific medications, and at location 470, the infusion nurse forwards all paperwork to the nurse practitioner. At location 472, the nurse practitioner reviews the printout and notes using an APHID algorithm, at location 474, the nurse practitioner interviews the patient, at location 476, any high-risk discrepancies are addressed, at location 478, any oncology discrepancies are addressed, at location 480, any charted discrepancies are noted and additional discrepancies are forwarded to the primary care doctor/facility, and at location 482, the after-clinic summary note is given to the patient.

The APHID system of the invention thus provides a feasible model to align the safety and efficiency needs of a health system by gathering of medication history and supporting clinic throughput.

Although several embodiments of this invention have been described above with a certain degree of particularity, those skilled in the art may make numerous alterations to the disclosed embodiments without departing from the scope of this invention. All directional references (e.g., upper, lower, upward, downward, left, right, leftward, rightward, top, bottom, above, below, vertical, horizontal, clockwise and counterclockwise) are only used for identification purposes to aid the readers understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not as limiting. Changes in detail or structure may be made without departing from the invention as defined in the appended claims.

What is claimed is:

1. A system of automated patient history intake comprising:
a retrieval system for retrieving pharmaceutical information specific to a patient;
a display system for displaying the pharmaceutical information; and
a reconciliation system for reconciling the pharmaceutical information using visual data.

2. The system according to claim 1, wherein the visual data includes images of a medication.

3. A system for automated patient check-in comprising:
a retrieval system for retrieving pharmaceutical information specific to a patient;
a display system for displaying the pharmaceutical information; and
a reconciliation system for reconciling the pharmaceutical information using visual data.

4. The system according to claim 3, wherein the visual data includes images of a medication.

5. A method of automated patient history intake comprising:
retrieving pharmaceutical information specific to a patient;
displaying the pharmaceutical information; and
reconciling the pharmaceutical information using visual data.

6. A method of automated patient check-in comprising:
retrieving pharmaceutical information specific to a patient;
displaying the pharmaceutical information; and
reconciling the pharmaceutical information using visual data.
